(19) United States
(12) Patent Application Publication
(10) Pub. No.: US 2025/0230066 A1
(43) Pub. Date: Jul. 17, 2025

(54) STEAM-ACTIVATED CARBON NANOPARTICLES OF OIL FLY ASH AND DATE PALM FRONDS FOR CONTAMINANT REMOVAL FROM WATER

(71) Applicant: King Abdulaziz University, Jeddah (SA)

(72) Inventors: Numan Salah, Jeddah (SA); Shittu Abdullahi, Jeddah (SA); Mohammed Aslam, Jeddah (SA); Mohammed Omish Ansari, Jeddah (SA); Ahmad Hamisu, Jeddah (SA); Yousef N. Salah, Jeddah (SA); Ahmed Alshahrie, Jeddah (SA); Asim Jelani, Jeddah (SA); Adnan Memic, Jeddah (SA); Javed Iqbal, Jeddah (SA)

(21) Appl. No.: 18/641,744

(22) Filed: Apr. 22, 2024

Related U.S. Application Data
(62) Division of application No. 18/414,667, filed on Jan. 17, 2024.

(51) Int. Cl. C02F 1/28; B01J 20/20; B01J 20/28; B01J 20/30; B01J 20/32; C01B 32/324; C01B 32/354; C02F 101/20; C02F 101/30

(52) U.S. Cl. CPC C02F 1/283; B01J 20/205; B01J 20/28007; B01J 20/28019; B01J 20/28026; B01J 20/2803; B01J 20/28061; B01J 20/3021; B01J 20/3071; B01J 20/3078; B01J 20/3295; C01B 32/324; C01B 32/382; C02F 2101/20; C02F 2101/308

(57) ABSTRACT

A method for removing contaminants from an aqueous solution is provided. The method includes contacting the aqueous solution with steam-activated carbon nanoparticles obtained from oil fly ash and/or date palm fronds under conditions sufficient to adsorb contaminants to the carbon nanoparticles, wherein the carbon nanoparticles are formed into pellets or coated on a fabric sheet. Fabric sheets coated with the carbon nanoparticles are also provided.

### FIELD OF THE INVENTION

The invention is generally related to the use of carbon nanoparticles obtained from oil fly ash and date palm fronds for the effective removal of organic pollutants, heavy metals, and other toxic contaminants from water.

### BACKGROUND OF THE INVENTION

Less than 1% of all water on Earth is available as freshwater and we are using more and more of this precious resource. In the Middle East (ME), there is a serious shortage of fresh water, where there is less than 500 m³ of water per person on an annual basis, well below the world average of >1500 m³ per person [1]. Furthermore, the constantly depleting groundwater table in the region has accelerated seawater intrusion, rendering even the scarcely available fresh water sources brackish, with average salt concentrations of ˜ 5 g/l [2]. Consequently, the ME has opted for seawater desalination to support most of its water requirements. The depletion of clean water resources is a major challenge worldwide that is further complicated due to the pollution caused by the discharge of toxic effluents into water bodies. According to a report from the World Health Organization (WHO), around 750 million people on the planet do not have access to safe water and the ongoing water scarcity due to industrialization, population growth, and urbanization increases the water stress in all regions [3, 4]. We must learn to reuse water. This requires a complex process of transformation to implement knowledge, tools, and new materials/technologies to make a paradigm shift from linear water consumption to circular water management.

It is well understood that water is an essential part of many industries. It is needed for different industrial operations like power generation, textile industry, mining, oil and gas production, petrochemical industry, food industry, medicine and pharmaceutical industry, etc. Some of these industries require huge amounts of water for the execution of their respective processes like petrochemical refining, textile industry, paper production industry, ore extraction and mineral processing, pharmaceutical production, fruits and vegetables packaging, food industry, etc. [5-10]. The availability of water in a high quantity and good quality can have a significant influence on business operations and profitability [11]. Highly effective management of water resources is therefore needed to ensure the sustainability and durability of the industry operations. It becomes critical for industries to reserve freshwater and avoid any disposal of wastewater [12]. Additionally, discharging industrial wastewater with no proper management can cause more pollution, leading to severe environmental and health issues [13]. Some efforts were adopted to introduce various wastewater treatment technologies, including chemical, physical, and biological treatment methods that might solve these issues.

There are several existing wastewater management techniques described in the literature [15], which were employed to treat and manage wastewater. Chemical treatment processes are common to remove pollutants from wastewater. It includes oxidation, adsorption, and precipitation [16], which consists of the use of physical processes; filtration, membrane separation, and sedimentation [17]. Another common method is biological treatment processes, which include activated sludge, trickling filters, and anaerobic digestion [18]. Chemicals like oxidants, coagulants, and flocculants are used in this process to remove pollutants from wastewater. However, the existing wastewater management techniques may fail or be ineffective in achieving the desired outcomes as some of them use facilities and materials that are outdated or insufficient to effectively remove pollutants and contaminants from the wastewater [19]. The high cost of some of the used materials is also another challenge, which limits their wide use to treat and reuse whole quantities of industrial wastewater.

Amongst the above-mentioned techniques of wastewater treatment, the adsorption process seems to be the ultimate choice as a wastewater remediation technique due to the simplicity of the process. This technique mostly depends on activated carbon extracted from coconut shells [20]. However, for better efficiency and wider selectivity alternative materials were also proposed and extensively evaluated for water treatment. These include biomaterials [21], clay [22], coal fly ash [23], nanomaterials [24,25] etc. Nanomaterials were considered proper candidates as highly effective adsorbents for wastewater remediation due to their high surface area and high adsorption capacity. Although some of these nanomaterials have great potential for wastewater treatment, they exhibit high health risks, higher cost of production, specific selectivity, low sustainability, and low recyclability [26]. Amongst nanomaterials, carbon nanostructures seem to have a higher potential for wastewater treatment due to their attractive physicochemical properties [27]. These include carbon nanotubes (CNTs) in their multi-walled- and single-walled forms, graphene, and graphene oxide-based nanomaterials, and carbon and graphene quantum dots-derived nanomaterials. They are safe and more effective in adsorbing pollutants on their surfaces and can be easily used for water treatment applications. However, the production cost of such carbon nanomaterials is still a major challenge, mainly if we plan to produce them in large quantities and at a minimum reasonable cost.

In view of the disadvantages of previous methods, improved materials for wastewater treatment are needed.

### SUMMARY

Described herein are highly effective adsorbent materials made of steam-activated nanoparticles of oil fly ash and date palm fronds useful for water treatment/purification. Oil fly ash and date palms trees are available in huge quantities in countries such as Saudi Arabia and treated as solid wastes, therefore converting them into nanomaterials is quite important for many applications.

An aspect of the disclosure provides a method for removing contaminants from an aqueous solution, comprising contacting the aqueous solution with steam-activated carbon nanoparticles obtained from oil fly ash and/or date palm fronds under conditions sufficient to adsorb contaminants to the carbon nanoparticles, wherein the carbon nanoparticles are formed into pellets or coated on a fabric sheet.

In some embodiments, the carbon nanoparticles are activated at a temperature of 750-950° C. In some embodiments, the pellets have a surface area of 4-300 mm². In some embodiments, the carbon nanoparticles are mixed with a binder before being coated onto the fabric sheet. In some embodiments, the mixture contains 80-95% carbon nanoparticles and 5-20% binder. In some embodiments, the binder is poly (methyl methacrylate) (PMMA). In some embodiments, the aqueous solution is maintained at a pH from 6-7 during the contacting step. In some embodiments, the aqueous solution is industrial wastewater. In some embodiments, the contaminants include one or more heavy metals. In some embodiments, the one or more heavy metals are selected from the group consisting of Ag, Al, B, Ba, Ca, Cd, Co, Cr, Cu, Fe, K, Li, Mg, Mn, Na, Ni, Pb, Sr, Zn, and salts thereof. In some embodiments, the contaminants include one or more dyes. In some embodiments, the one or more dyes are selected from the group consisting of methylene blue (MB), crystal violet (CV), brilliant green (BG), and methyl green (MG). In some embodiments, the step of contacting removes at least 80% of heavy metals and/or dyes from the solution relative to an initial concentration.

Another aspect of the disclosure provides a method for removing contaminants from an aqueous solution, comprising ball milling oil fly ash and/or date palm fronds to form carbon nanoparticles; steam activating the carbon nanoparticles to form steam-activated carbon nanoparticles; and contacting an aqueous solution with the steam-activated carbon nanoparticles under conditions sufficient to adsorb contaminants to the carbon nanoparticles, wherein the carbon nanoparticles are formed into pellets or coated on a fabric sheet.

Another aspect of the disclosure provides a fabric sheet, wherein the sheet is coated with steam-activated carbon nanoparticles obtained from oil fly ash and/or date palm fronds. In some embodiments, the sheet is further coated with a binder mixed with the steam-activated carbon nanoparticles. In some embodiments, the sheet is coated with a mixture of 80-95% carbon nanoparticles and 5-20% binder. In some embodiments, the binder is poly (methyl methacrylate) (PMMA). In some embodiments, the sheet is formed from polystyrene.

### BRIEF DESCRIPTION OF THE DRAWINGS

FIG. 1. Oil fly ash samples collected from the power plant and their reduction into nanoparticles using the high-energy ball milling technique. Their elemental analysis using EDX and Raman spectrum are also shown after their washing with acid and water.

FIG. 2. Customized horizontal tube furnace with steam flow under nitrogen carrier gas used for activating the nanoparticles of oil fly ash and date palms fronds. The inset shows a ceramic boat with a powder sample.

FIG. 3. Method for producing pellets using CNPs of steam-activated oil fly ash powder.

FIG. 4. Carbonization and ball milling of date palm fronds.

FIG. 5. Date palm fronds and their reduction into ultrafine nanoparticles using the high-energy ball milling technique. Their elemental analysis using EDX and Raman spectrum is also shown. The date palm fronds were collected from a farm north of Jeddah (Thahbban).

FIG. 6. Fabric coating with CNPs of fly ash and date palm fronds using drop casting technique.

FIGS. 7A-B. (A) Specific surface area at different ball milling intervals. (B) Specific surface area of 15 hours ball milled date palm frond powder at various temperatures.

FIGS. 8A-D. The effect of dose on the adsorption performance of steam-activated CNPs of oil fly ash powder in a 5-ppm solution of different organic pollutants: (A) 5 mg, (B) 10 mg, (C) 20 mg, and (D) 50 mg.

FIGS. 9A-D. The effect of dose on the adsorption performance of steam-activated CNPs of date palm fronds in a 5-ppm solution of different organic pollutants: (A) 5 mg, (B) 10 mg, (C) 20 mg, and (D) 50 mg.

FIGS. 10A-D. The adsorption of different pollutants at different concentrations of the steam-activated CNPs powder: (A) CNPs of date palm fronds at a fixed adsorption time of 2 minutes, (B) CNPs of date palm fronds at a fixed adsorption time of 5 minutes, (C) CNPs of oil fly ash at a fixed adsorption time of 2 minutes, and (D) CNPs of oil fly ash at a fixed adsorption time of 5 minutes.

FIGS. 11A-D. The adsorption response of the CNPs of date palm fronds coated fabrics 10 in different pollutants: (A) methylene blue, (B) brilliant green, (C) methyl green, and (D) crystal violet. These results were collected at CNPs concentrations equal to 1, 2, and 4 mg/ml.

FIGS. 12A-B. The absorbance of different pollutants and their mixture versus concentration of steam-activated CNPs of date palm fronds at (A) 30 minutes and (B) 60 minutes.

FIGS. 13A-B. The adsorption performance of CNPs of oil fly ash-coated fabrics with (A) 20% PMMA or (B) 5% PMMA in different pollutants at a fixed concentration of 4 mg/ml (i.e., 200 mg of CNPs of oil fly ash in 50 ml of DI water).

FIGS. 14A-B. The adsorption performance of pellets made of steam activated CNPs of oil fly ash (containing 4% PMMA) at two different concentrations: (A) 40 mg/ml (2 g in 50 ml of dye solutions), and (B) 80 mg/ml (4 g in 50 ml of dye solutions).

20 FIGS. 15A-B. Effects of total pellet area on the adsorption performance of different concentrations: (A) 80 mg/ml and (B) 40 mg/ml. These pellets were made of steam activated CNPs of oil fly ash.

FIGS. 16A-B. The percentage metal removal in a mixed metal solution by carbon nanoparticles of fly ash and other materials. The adsorbent materials have a concentration of 100 mg/100 mL, at pH 6-7 (A) at 60 min (B) at 120 min (BM: stands for ball milled, AC: stands for activated).

FIGS. 17A-B. Selected metal removal present in a mixed solution by carbon nanoparticles of fly ash and other materials. The adsorbent materials have a concentration of 200 mg/100 mL, at pH 6-7, (A) at 30 min (B) at 60 min (BM: stand for ball milled, AC: stand for activated). 30 FIGS. 18A-B. Selected metal removal present in a mixed solution by carbon nanoparticles of fly ash and other materials. The adsorbent materials have a concentration of 200 mg/100 mL, at pH 4-5, (A) at 30 min (B) at 60 min (BM: stand for ball milled, ACL stand for activated).

FIGS. 19A-B. Selected metal removal present in a mixed solution by carbon nanoparticles of fly ash and other materials. The adsorbent materials have a concentration of 200 mg/100 mL, at pH 8-9, (A) at 30 min (B) at 60 min (BM: stand for ball milled, AC: stand for activated).

FIG. 20. Selected metal removal present in a mixed solution by unloaded fabrics and carbon nanoparticles of fly ash coated fabrics for two different times. The adsorbent materials have a concentration of 200 mg/100 mL, at pH 6-7 (BM: stand for ball milled, AC: stand for activated).

### DETAILED DESCRIPTION

Embodiments of the disclosure provide compositions and methods for the removal of contaminants from an aqueous solution. The compositions comprise adsorbent materials made of steam-activated carbon nanoparticles of oil fly ash and date palm fronds. The adsorbent material may be produced in the form of pellets/grains or may be adhered to a fabric surface to make flexible sheets. The materials are useful as adsorbents for different organic pollutants and heavy metals to use in wastewater treatment applications.

One of the most common solid waste materials is fly ash. This material is a by-product formed due to the use of coal or heavy/crude oil as a fuel in factories or power production plants. The main difference between oil fly ash (OFA) and coal fly ash is the carbon content. Coal fly ash has a small amount of carbon, while the major part is oxide compounds. OFA is mostly composed of unburnt carbon, which can make up more than 90% of the ash. In some embodiments, the OFA has a carbon content of greater than about 65 wt. %, e.g. greater than about 70, 75, 80, 85, 90, 95, 96, 97, 98, or 99 wt. %. OFA also contains higher levels of certain heavy metals, such as vanadium and nickel, compared to other types of fly ash. OFA also contains a high concentration of other valuable metals/elements such as Pr, Ce, Tb, Dy, Yb, Te, and Mo, compared to other types of fly ash.

Phoenix dactylifera, commonly known as date or date palm, is a flowering plant species in the palm family, Arecaceae, cultivated for its edible sweet fruit. The species is widely cultivated across Northern Africa, the Middle East, the Horn of Africa and South Asia, and is naturalized in many tropical and subtropical regions worldwide. P. dactylifera is the type species of genus Phoenix, which contains 12-19 species of wild date palms, and is the major source of commercial production.

Carbon nanoparticles may be obtained from OFA and date palm fronds/leaves using ball milling techniques, e.g. as described in U.S. Pat. Nos. 10,906,812 and 11,110,429 incorporated herein by reference. High-energy ball milling techniques are known in the art and generally require the use of metallic or ceramic jars and balls. This technique mechanically deforms the solid materials into very fine nanomaterials in powder form. The ball milling is normally conducted using rigid balls in a high energy rotating mill, where irregular-grained structures experience deformation as the result of severe cyclic distortion. Small ultrafine particles with sizes less than 10 nm can be produced. This technique can be scaled to produce high quantities (Tons) of nanomaterials. The contamination problem due to the use of metallic jars and balls is resolved by coating with hard-ceramic materials such as tungsten carbide, alumina, or zirconia. In some embodiments, the nanomaterials described herein are produced without using sonication.

In some embodiments, nanoparticles described herein have an average particle size of about 1-150 nm.

The carbon nanoparticles are activated via steam activation to increase the surface area. In some embodiments, the nanoparticles are activated at a temperature of 750-950° C. For example, nanoparticles from date palm fronds are activated at a temperature of 750-850° C., e.g. about 800° C. In other embodiments, nanoparticles from OFA are activated at a temperature of 850-950° C., e.g. about 900° C.

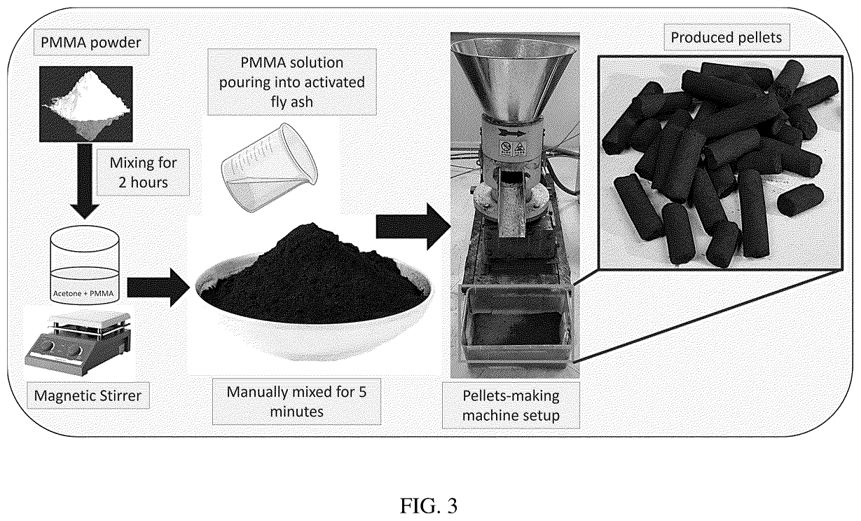

The activated nanoparticle composition can be formed into different shapes like sheets, pellets/grains, or sponges with or without the addition of suitable binders. An exemplary pellet shape is shown in FIG. 3. In some embodiments, the pellets have a surface area of 4-300 mm².

In some embodiments, the activated nanoparticle composition is coated on a fabric sheet, e.g. a polystyrene sheet, silk, cotton, and wool. The coating may be performed, e.g. using a drop-casting method. The nanoparticles may be coated on one or both sides of the fabric sheet. The nanoparticle composition may coat at least 80-100% of the fabric surface. Optionally, the nanoparticle composition may be mixed with a binder prior to being coated on the fabric sheet. Suitable binders include, but are not limited to, poly (methyl methacrylate) (PMMA), polyvinylidene fluoride (PVDF), and polycarbonate (PC). In some embodiments, the mixture contains about 80-95 wt. % carbon nanoparticles and about 5-20 wt. % binder.

Embodiments of the disclosure also include methods of preparing a nanoparticle composition, e.g. in pellet form or coated on a fabric sheet, as described herein. In some embodiments, the particles are ball milled for at least 8-20 hours. After the ball milling process, the powder sample may be acid treated, e.g. to remove unwanted oxides/metal oxides in the fly ash and to induce some functional groups at their surfaces.

Embodiments of the disclosure also provide methods for removing contaminants from an aqueous solution, comprising contacting the aqueous solution with steam-activated carbon nanoparticles obtained from oil fly ash and/or date palm fronds under conditions sufficient to adsorb contaminants to the carbon nanoparticles, wherein the carbon nanoparticles are formed into pellets or coated on a fabric sheet. The methods are useful for the removal of various pollutants, including, but not limited to, organic pollutants (e.g., pharmaceuticals, polycyclic aromatic hydrocarbons, organic dyes, pesticides, polychlorinated biphenyls), heavy metals (e.g., mercury, copper, chromium, lead), microorganisms (e.g., bacteria), or any other unwanted component present in water.

As used herein, “heavy metals” include all metals, metalloids or any other known forms that are toxic to human, animal life or environment even at lower concentrations. The terms “heavy metal” and “toxic metal” are used interchangeably herein. In some embodiments, the one or more heavy metals are selected from the group consisting of Ag, Al, B, Ba, Ca, Cd, Co, Cr, Cu, Fe, K, Li, Mg, Mn, Na, Ni, Pb, Sr, Zn, and salts thereof.

In some embodiments, the contaminants include one or more dyes, e.g. organic dyes. In some embodiments, exemplary dyes include, but are not limited to, methylene blue (MB), crystal violet (CV), brilliant green (BG), and methyl green (MG).

In some embodiments, the step of contacting removes at least 80% of heavy metals and/or dyes from the solution relative to an initial concentration, e.g. at least 85, 90, 95, 96, 97, 98, 99, or 100%. The % removal can be calculated by measuring the absorbance spectrum of the solution before and after the contacting using UV-vis, with the absorbance intensity being correlated to the concentration of a pollutant using a standard curve.

The contaminant/pollutant may be present in the solution at concentrations up to 1000 ppm, for example, up to 500 ppm or 200 ppm.

The term “aqueous solution” encompasses any of the water types as described herein. Non-limiting examples of water sources include, but are not limited to, surface water that collects on the ground or in a stream, aquifer, river, lake, reservoir or ocean, ground water that is obtained by drilling wells, run-off, industrial wastewater (e.g., wastewater produced by petrochemical and manufacturing industries), public water storage towers, public recreational pools and/or bottled water. In some embodiments, the water is sourced from fresh water (contains less than 0.05% salinity), brackish water (contains 0.05-3% dissolved salts), saline or seawater (contains 3-5% dissolved salts), or brine (contains greater than 5% dissolved salts), with % being a % by weight based on the total solution weight).

Suitable conditions for adsorption may include maintaining the solution at a pH of 5 to 8, e.g. about 6-7. In some embodiments, the solution is maintained at a temperature of 20 to 60° C., e.g. about 25 to 50° C. In some embodiments, the contacting step is performed for 1 to 90 minutes, e.g. about 30 to 60 minutes. In some embodiments about 0.1 to 4.0 g of the nanoparticle composition is employed per liter of the water during the contacting.

In some embodiments, after contacting, the nanoparticle composition is removed from the solution and may optionally be recycled upon treatment with an organic solvent (e.g., methanol, acetone, etc.), a mineral acid (e.g., hydrochloric acid, sulfuric acid), and/or a hydroxide base (e.g., sodium hydroxide, potassium hydroxide) to desorb the pollutant. After drying, the composition may then be reused in the method described herein with no or minimal loss in absorbency.

In some embodiments, pellets or fabric sheet are incorporated into a filter. The filter can be designed in a variety of forms, e.g. comprising a candle, a porous block (radial and/or vertical), a filter bed, a packet, a bag, and the like.

A weight percent of a component, unless specifically stated to the contrary, is based on the total weight of the formulation or composition in which the component is included. For example if a particular element or component in a composition or article is said to have 8 wt. %, it is understood that this percentage is in relation to a total compositional percentage of 100%. Further, with respect to the composition of fly ash or date palm, the dry weight basis is used. That is, the wt. % is based on a total weight of dried material so that a weight of water does not significantly contribute to the total weight of material, unless stated otherwise.

As used herein, the term “about” refers to a ±10% variation from the nominal value unless otherwise indicated.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLE

### Summary

In countries with a shortage of freshwater, the necessity for water treatment and its reuse particularly in industry is of great importance, mainly in a country like Saudi Arabia. It is well known that industrial wastewater mostly contains organic pollutants, heavy metals, and other toxic contaminants. However, very effective and low-cost materials are needed for water treatment, particularly those that are available at low cost and in high quantity. In this work, carbon nanoparticles (CNPs) of oil fly ash in their pellet and fabric-coated forms and ultrafine CNPs of date palm fronds coated on fabrics were prepared and were found to be very effective in removing organic pollutants and toxic heavy elements. These CNPs were reduced into the nanoscale and subjected to steam activation at 800° C. to increase their surface area for maximum adsorption of organic and inorganic pollutants. The steam-activated nanoparticles were formed in pellets and coated fabric sheets and finally evaluated for the adsorption of organic pollutants like methylene blue (MB), crystal violet (CV), brilliant green (BG), and methyl green (MG). Additionally, they were tested for the adsorption of mono-, di-, and trivalent metals, such as Ag, Al, B, Ba, Ca, Cd, Co, Cr, Cu, Fe, K, Li, Mg, Mn, Na, Ni, Pb, Sr, and Zn, which are the most abundant pollutants in industrial wastewater. The performance is excellent, mainly with some elements/ions like Ag, Al, Ba, Cd, K, Li, Ni, and Pb, which have been significantly removed, even better than those removed by a commercially activated carbon. These carbon nanostructures in pellet forms and fabric-coated sheets are quite effective for industrial wastewater pollutant removal for saving huge amounts of freshwater.

### Materials and Methods

### Carbon Nanoparticles of Oil Fly Ash; Synthesis and Purification

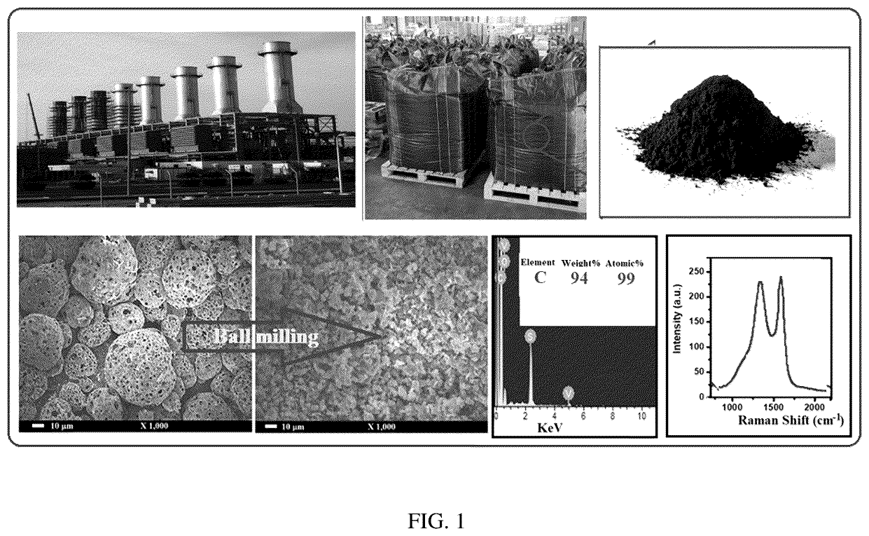

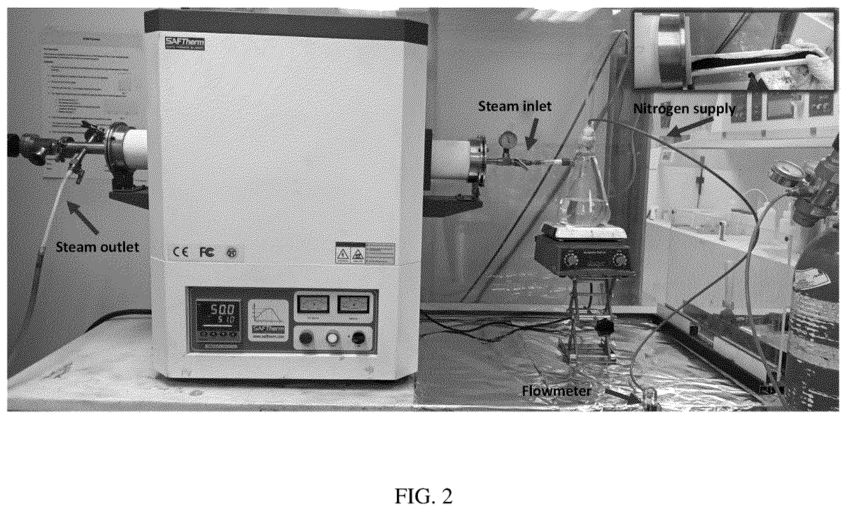

The nanoparticles of oil fly ash and date palm fronds were produced by the same methods described previously [43-45, 56-60]. The oil fly ash powder used in this work was supplied from Rabigh power plant (FIG. 1). After their production, they were steam activated for the first time and then formed in new final forms for their performance as pollutant adsorbents. Briefly, the nanoparticles of oil fly ash were produced by the high-energy ball milling technique. In a typical experiment, 80 gm of oil fly ash powder sample was ball milled for 15 h in 4 steel cells (of a capacity of 250 mL for each) using 5 hardened steel balls in every cell (diameter of the ball 15 mm, weight 32 gm) in ambient conditions. The mechanical milling was performed in a horizontal oscillatory mill (PM 400; Retsch, Hann, Germany) operating at 25 Hz. The milled materials were used directly with no added milling media. Five balls were kept in each cell along with 20 g of the sample powder. Then after the ball milling process, the powder sample was collected and treated using the acid method. This will remove the unwanted oxides/metal oxides in the fly ash and also can induce some functional groups at their surfaces. The powder sample was soaked in 500 mL DI water and stirred for 2 h. After stirring, the mixture is allowed to settle for 30 min before the water is decanted and the procedure is repeated 3 times which gives a slurry phase. This slurry was subsequently dried in an oven at 70-80° C. temperature for 12-18 h and stored until used for the batch treatment experiments. The washed ball-milled oil fly ash sample was then soaked in 100 mL of 1 M HNO₃. The mixture was refluxed at 110° C. for 24 h. The acid is allowed to evaporate at 60° C., after which the reaction mixture is diluted with 500 mL DI water until the pH of the filtrate becomes neutral. The residue is then dried in the oven at 105° C. for 72 h. The purity of the nanoparticles after their washing with water and acids reached approximately 99 atm % as shown in FIG. 1.

### Carbon Nanoparticles of Oil Fly Ash Activation

The activation of the produced nanoparticles of oil fly ash was done physically in a horizontal tube furnace at 900° C. using water steam and N₂ as a carrier gas. Typically, around 10 gm of the powder sample was kept in a flat big crucible and then inserted inside the horizontal tube furnace. The tube is evacuated and heated to 200° C. at the rate of 5° C./min and after 200° C. at the rate of 7° C./min. At 300° C., the nitrogen gas was passed into the furnace allowing the temperature to rise further. The steam flow was started at different temperatures e.g., at 600, 700, 800, 900, and 1000° C. for 1 hr. The optimum temperature for higher surface area (BET) is found to be 900° C. The water steam was generated by heating around 200 ml of water in a flask, which has two inlets, one inlet is connected to the tube furnace, and the other one is connected to N₂ gas (FIG. 2). When the temperature of the furnace reached 900° C. the water steam was purged at an N₂ flow rate of 100-150 sccm/min and continued for 90 min. Finally, the furnace was cooled down and the samples were collected and kept in airtight bottles. The experiment was repeated to activate the whole amount of the ball-milled sample (˜80 gm). A small part of the sample by around 5-8% is lost due to steam activation, The activation is quite effective in improving the surface area and enhancing the efficiency for pollutant adsorption.

### Pellet and Fabric Sheet Formation Using CNPs of Steam-Activated Oil Fly Ash

The production of pellets of CNPs of oil fly ash was achieved by dissolving ˜20 gm of Poly (methyl methacrylate) (PMMA) in 500 ml of acetone at constant stirring for 2 h. The solution was later added to the 480 gm of a ball-milled, steam-activated oil fly ash powder, and manually mixed for about 5 minutes till it becomes almost dry with slight wet and fed into the pellet-making machine as shown in FIG. 3. The produced pellets were then left to dry at room temperature for 24 hours before washing them with DI water and redried for another 24 hours at 60° C. to remove any residue. The average length and diameter of the fabricated pellets was approximately 20 mm and 4 mm, respectively. Smaller pellets can also be produced just by changing the diameter of Template/Mold of the machine. The produced pellets were used as an adsorbent to evaluate the removal efficiency of organic and inorganic pollutants.

Polystyrene fabric sheet supplied from a local clothes market was used as a substrate to coat a thin layer of steam-activated carbon nanoparticles of oil fly ash on both sides of the sheet by drop casting technique. Initially ˜1 gm of PMMA as a binder was completely dissolved in 5-7 ml of acetone with constant magnetic stirring. Approximately 8 gm of carbon nanoparticles of steam activated CNPs of oil fly ash was added gradually and mixed using a magnetic stirrer for 120 min. Finally we drop cast the solution into a Petri dish containing the fabric substrates and air dried for 24 h at room temperature. The casted fabrics are finally annealed at 60° C. for 3 h, then packed and kept in the laboratory for analysis.

Carbon Nanoparticles of Date Palm Fronds and their Steam Activation

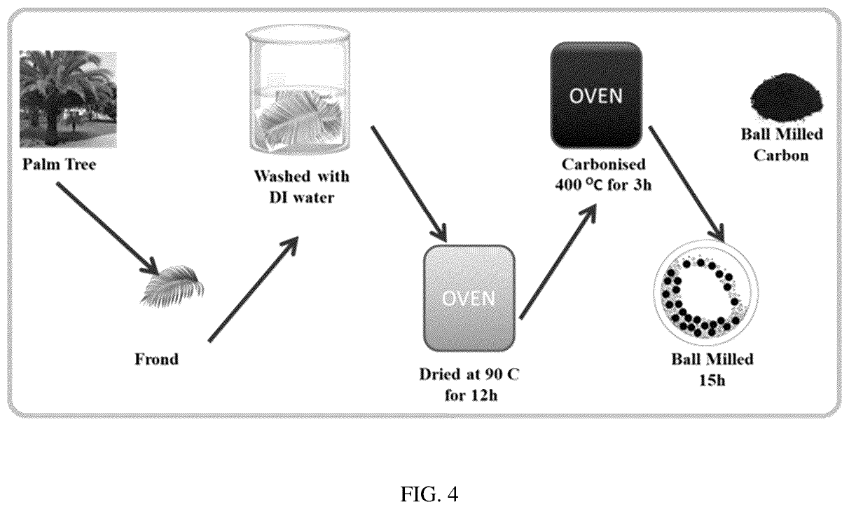

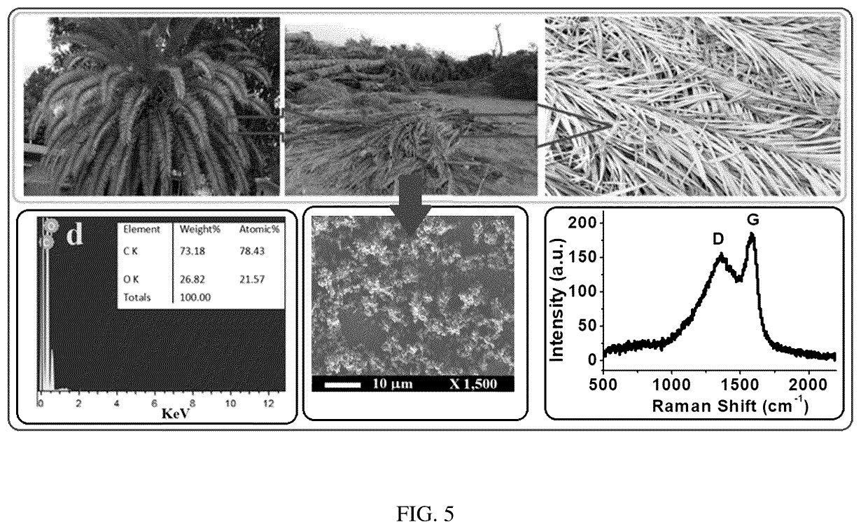

The nanoparticles of date palm fronds were produced by the same method described previously [56-60]. In this method, date palm fronds were collected and cut into small pieces and then washed with DI water. After drying these samples at 90° C. for 12 h, they were carbonized at 400° C. for 3 hrs using a muffle furnace as shown in FIG. 4. This was performed by using a closed crucible having small holes on its cover. The carbonized samples were reduced into ultrafine carbon nanoparticles at sizes less than 10 nm using the high-energy ball milling technique for 15 hrs. Ten to eight hours are also enough to reduce the particles size to the nanoscale range. FIG. 5 shows SEM, EDX, and Raman analysis for the produced nanoparticles. Removal of the ash continent can also be minimized by acid treatment (e.g. reflexing at 100° C. in HNO₃ for 12 hrs, then washing then drying). The produced ultrafine carbon nanoparticles of carbonized date palm fronds were physically activated by DI steam. The activation was performed using the set-up described above, which is shown in FIG. 2. The steam activation for the CNPs of date palm fronds was performed at 800° C. using water steam and N₂ as a carrier gas. The same conditions used for activating the nanoparticles of oil fly ash are used here, except the activation temperature, which was optimized to be 800° C. for 90 min. When the temperature of the furnace reached 800° C. the water steam was purged at an N₂ flow rate of 50 sccm/min and continued for 90 min. After cooling the furnace to room temperature, the samples were collected. Around 25-30 wt % of the sample was lost due to steam activation.

Fabric Coating with CNPs of Steam-Activated Date Palm Fronds

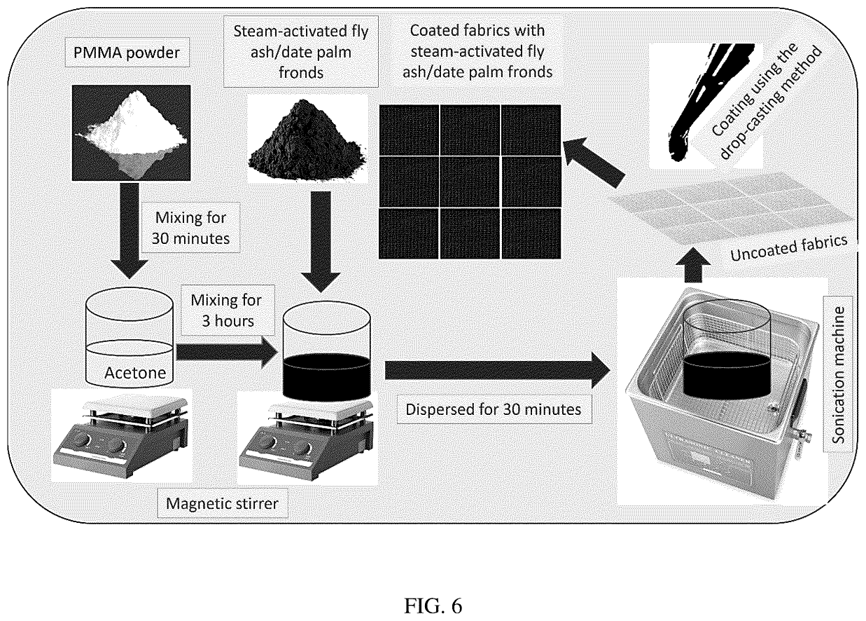

Similar to the fabrics of oil fly ash nanoparticles, a polystyrene fabric sheet was used as a substrate to coat a thin layer of steam-activated carbon nanoparticles of date palm fronds on both sides of the sheet by applying drop cast technique as described above and shown in FIG. 6. Initially, around 1 gm of PMMA as a binder was completely dissolved in 5-7 ml of acetone, then into this solution 8 gm of carbon nanoparticles of steam activated date palm fronds was added and mixed using a magnetic stirrer for 120 min. Finally, we drop cast the solution into a Petri dish containing the fabric substrates and left to dry for 24 h at room temperature before annealing them at 60° C. for 3 h. After that, the coated fabrics were washed with DI water to remove any residue. The fabrics are then redried at 60° C. for 3 h, then packed and kept in the laboratory for analysis.

### Pollutant Adsorption Studies

Batch adsorption studies were executed for the reliability of the steam-activated nanoparticles of oil fly ash and date palm fronds in powder and pellet/sheet forms. This was done by optimizing the parameters viz. contact time, contaminants concentration, and dosage of absorbent.

### Heavy Metals Adsorption Studies

For heavy metals adsorption, a specific amount of the as-synthesized adsorbents such as CNPs of oil fly ash powder (Ball milled oil fly ash, BM), washed CNPs of oil fly ash powder, activated CNPs of oil fly ash coated fabric, and non-activated CNPs of oil fly ash coated fabric and also commercial activated carbon powder, were tested for heavy metals removal. Other adsorbents like a powder mixture of activated CNPs of oil fly ash with chitosan, a powder mixture of activated CNPs of date palm fronds with chitosan, and pure chitosan powder were also included in this study. They were tested for their adsorption of a good number of metals. The desired adsorbent was suspended to a 5 ppm of 100 ml mixed metal solution containing 20 metal ions. The adsorbents/adsorbates mixture was agitated on a mechanical shaker for a fixed period. The subsequent samples were centrifuged at 5000 rpm for 10 mins and filtered through 0.45 μm pore size membrane filter. The metal contents were analysed using the inductively coupled plasma spectrometer (ICPE-9000, Shimadzu). The quantification of metal content was performed in triplicate by ICP-OES technique. Before analysing the samples, the instrument was calibrated with a standard blank and the multi-element calibration standard. The analysis was started after getting the best linear regression correlation coefficient (R²≥0.9998) from the calibration plot. Prior to the analysis all the samples were also filtered through 0.45 μm disposable syringe filters and transferred to the sampling tube. All the analytical reference multi-element standards were purchased from AccuStandard, USA.

### BET Analysis

The specific surface area of the prepared CNPs of date palm fronds was investigated by the BET method using Nova Station, USA. Before the measurement, all the non-activated and steam activated CNPs of date palm fronds were degassed at 300° C. for 2 hours. The initial carbonized samples of date palm fronds without ball milling, was also examined for its surface area, which was found to exhibit a surface area of 38 m²/g. However, after conducting ball milling, a change in the specific surface area was observed, which was further influenced by the duration of ball milling. The BET analysis revealed surface areas of approximately 137 m²/g, respectively, for 15 hours. Notably, the results indicated that the increase in ball milling time did not significantly affect the specific surface area, as the samples milled for 10 hours and 15 hours demonstrated very close values of specific surface area, i.e., 122 m²/g and 137 m²/g. These results are consistent with previous reports suggesting that longer milling time does not necessarily lead to a greater surface area. Therefore, the sample ball milled for 15 hours was chosen for further steam activation. The sample activated at 800° C. exhibited a specific surface area of 420 m²/g. This increase in specific surface area from 137 m²/g to 420 m²/g highlights the role of steam activation in enhancing the surface area of the prepared ball-milled samples.

### Results

### Performance of the Steam-Activated CNPs of Oil Fly Ash

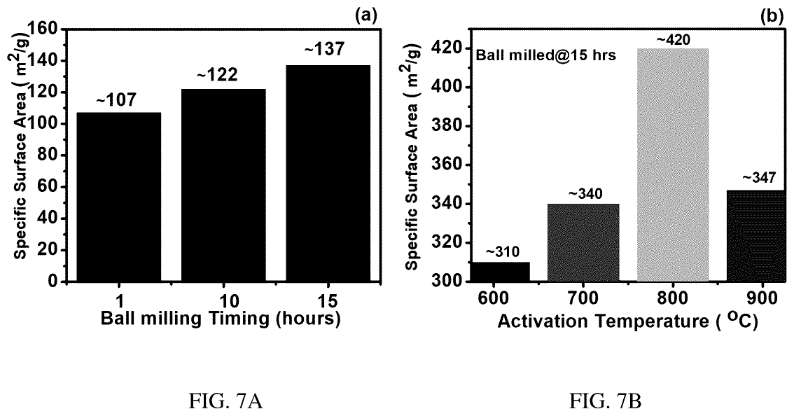

Various water pollutants such as dyes, heavy metals, and other carcinogenic substances can be adsorbed onto the catalyst's surface [61]. However, this adsorption is contingent upon the specific surface properties of the catalyst. Increasing the catalyst's surface area enhances the adsorption of pollutants due to the greater number of adsorption sites. Consequently, this leads to improved water quality. To investigate the specific surface area of the prepared samples, BET (Nova Station) was employed. Before the measurement, all the samples were degassed at 300° C. for 2 hours. The initial carbonized samples without ball milling exhibited a surface area of 38 m²/g. However, after conducting ball milling, a change in the specific surface area was observed, which was further influenced by the duration of ball milling. The ball milling was carried out at a fixed rotation speed of 200 rpm for durations of 1 hour, 10 hours, and 15 hours. The BET analysis revealed surface areas of approximately 107 m²/g, 122 m²/g, and 137 m²/g, respectively, for 1 hour, 10 hours, and 15 hours. Notably, the results indicated that the increase in ball milling time did not significantly affect the specific surface area, as the samples milled for 10 hours and 15 hours demonstrated very close values of specific surface area, i.e., 122 m²/g and 137 m²/g. These results are consistent with previous reports suggesting that longer milling time does not necessarily lead to a greater surface area [62]. Therefore, the sample ball milled for 15 hours was chosen for further steam activation (FIG. 7A). In this context, temperatures ranging from 600° C. to 900° C. were selected at intervals of 100° C. The CNPs of date palm fronds activated at 600° C. exhibited a specific surface area of 310 m²/g. This increase in specific surface area from 137 m²/g to 310 m²/g highlights the role of steam activation in enhancing the surface area of the prepared ball-milled samples. However, it was observed that an increase in the activation temperature resulted in changes to the specific surface area of the catalyst. Samples activated at 600° C., 800° C., and 900° C. respectively exhibited surface areas of approximately 340 m²/g, 420 m²/g, and 347 m²/g (FIG. 7B). Notably, an increase in activation temperature from 800° C. to 900° C. led to a decrease in surface area. This phenomenon is attributed to the fact that higher steam activation temperatures cause some pore structures to widen and collapse, resulting in a decrease in surface area and total pore volume, as reported by Pikkor et al. [64].

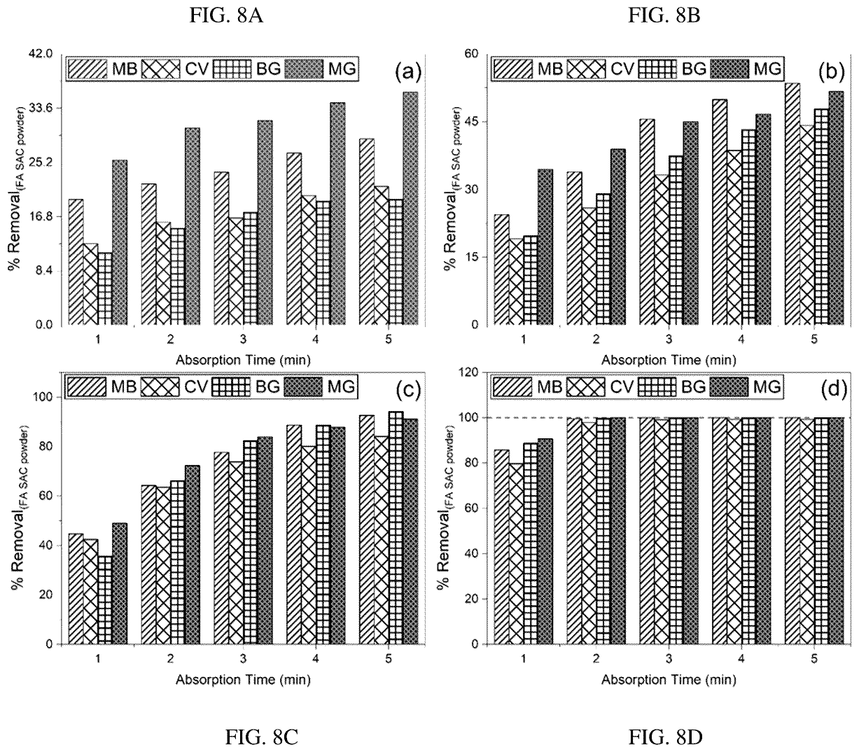

FIG. 8 shows the adsorption performance of steam-activated CNPs of oil fly ash powder over different organic pollutants. The tests were conducted by adding different quantities of powder (5 mg, 10 mg, 20 mg, and 50 mg, respectively) in 50 ml of 5 ppm dye solutions namely: methylene blue (MB), crystal violet (CV), brilliant green (BG), and methyl green (MG), respectively and tested for various adsorption times ranging from 1 to 5 minutes. It could be observed that increasing the amount of FA in the dye solutions increases the adsorption performance. For instance, increasing the amount from 5 mg to 50 mg improved the adsorption by more than 4 times in the MB solution, 6 times in the CV solution, 8 times in BG solution, and 4 times in MG solution, respectively within the first minute of adsorption time and continued for up to 5 minutes, as depicted in FIG. 8A-D. The summary of the adsorption percentage recorded from the powder is also presented in Table 1.

TABLE 1
Adsorption performance of steam-activated CNPs
of oil fly ash powder at different weights in
a 5-ppm solution of different organic pollutants.

| Adsorption Time | Dose | Adsorption % | | | |
|---|---|---|---|---|---|
| (min) | (mg) | MB | CV | BG | MG |
| 1 | 5 | 19.48 | 12.62 | 11.21 | 25.56 |
| 2 | | 21.87 | 15.95 | 15.02 | 30.56 |
| 3 | | 23.69 | 16.56 | 17.49 | 31.67 |
| 4 | | 26.65 | 20.07 | 19.21 | 34.44 |
| 5 | | 28.84 | 21.47 | 19.46 | 36.11 |
| 1 | 10 | 24.45 | 19.11 | 19.7 | 34.44 |
| 2 | | 33.91 | 25.94 | 29.06 | 38.89 |
| 3 | | 45.56 | 33.22 | 37.44 | 45 |
| 4 | | 49.86 | 38.65 | 43.23 | 46.67 |
| 5 | | 53.49 | 44.17 | 47.78 | 51.67 |
| 1 | 20 | 44.7 | 42.33 | 35.71 | 48.89 |
| 2 | | 64.18 | 63.54 | 66.13 | 72.22 |
| 3 | | 77.65 | 73.79 | 82.27 | 83.89 |
| 4 | | 88.63 | 80.02 | 88.67 | 87.78 |
| 5 | | 92.65 | 84.05 | 94.21 | 91.11 |
| 1 | 50 | 85.77 | 79.67 | 88.67 | 90.56 |
| 2 | | 99.52 | 97.9 | 99.75 | 100 |
| 3 | | 100 | 99.04 | 100 | 100 |
| 4 | | 100 | 99.3 | 100 | 100 |
| 5 | | 100 | 99.3 | 100 | 100 |

### Adsorption Performance of Steam-Activated CNPs of Date Palm Fronds Powder

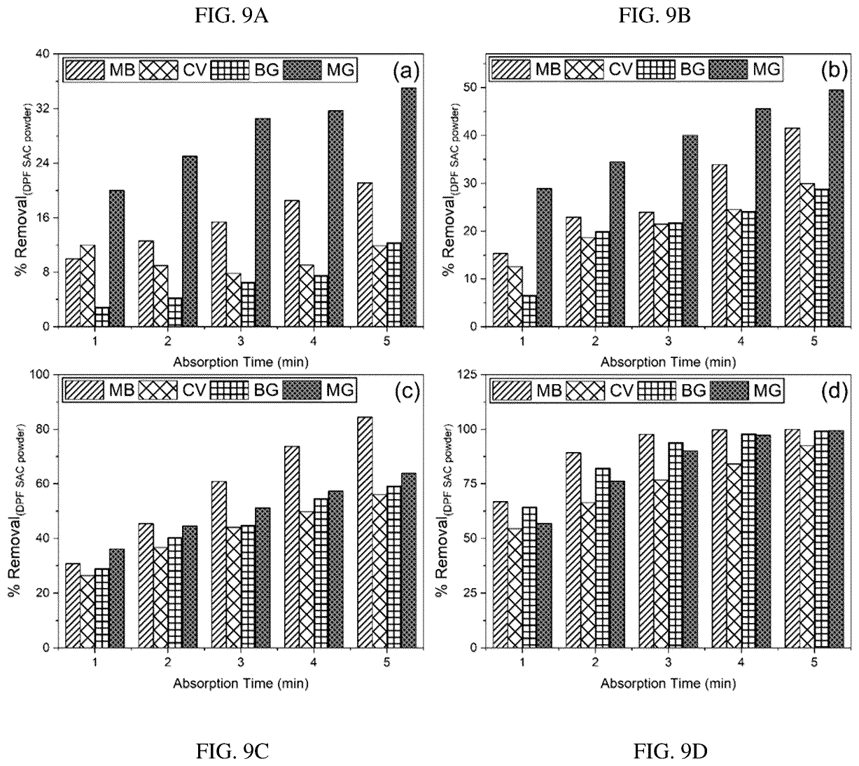

FIG. 9 shows the various adsorption performances of steam activated CNPs of date palm fronds powder over different organic pollutants at 1 to 5 minutes time span. FIG. 9A shows the percentage removal of 5 ppm dye solutions including MB, CV, BG, and MG over 5 g of adsorbent dose. FIG. 9B depicts a similar percentage adsorbed by 10 mg of sample, FIG. 9C illustrates the percentage absorbed by 20 mg of sample whereas FIG. 9D presents the percentage absorbed by 50 mg. The recorded performance across different quantities (5, 10, 20, and 50 mg) in the first minute of the adsorption time and the percentage adsorption increases with the increase of dose from 5 mg to 50 mg is depicted in FIGS. 9A-D and Table 2, respectively.

TABLE 2
The effect of dose on the adsorption performance of
steam-activated CNPs of date palm fronds powder in
a 5-ppm solution of different organic pollutants.

| | | |
|---|---|---|
| Adsorption Time | Dose | Adsorption % |

| (min) | (mg) | MB | CV | BG | MG |
|---|---|---|---|---|---|
| 1 | 5 | 9.93 | 12.01 | 2.83 | 20 |
| 2 | | 12.61 | 8.94 | 4.19 | 25 |
| 3 | | 15.38 | 7.8 | 6.53 | 30.56 |
| 4 | | 18.53 | 9.03 | 7.51 | 31.67 |
| 5 | | 21.11 | 11.92 | 12.32 | 35 |
| 1 | 10 | 15.38 | 12.53 | 6.53 | 28.89 |
| 2 | | 22.92 | 18.67 | 19.95 | 34.44 |
| 3 | | 23.97 | 21.47 | 21.8 | 40 |
| 4 | | 33.91 | 24.54 | 24.14 | 45.56 |
| 5 | | 41.55 | 29.97 | 28.82 | 49.44 |
| 1 | 20 | 30.75 | 26.38 | 28.94 | 36.11 |
| 2 | | 45.37 | 36.63 | 40.27 | 44.44 |
| 3 | | 60.74 | 44 | 44.7 | 51.11 |
| 4 | | 73.73 | 49.78 | 54.43 | 57.22 |
| 5 | | 84.43 | 56 | 58.99 | 63.89 |
| 1 | 50 | 66.67 | 54.34 | 64.29 | 56.67 |
| 2 | | 89.21 | 66.26 | 82.14 | 76.11 |
| 3 | | 97.71 | 76.6 | 93.97 | 90 |
| 4 | | 99.71 | 84.14 | 97.91 | 97.22 |
| 5 | | 99.9 | 92.55 | 99.14 | 99.44 |

### Effect of Different Concentrations of CNPs of Oil Fly Ash/Date Palm Fronds Powder in the Absorption Performance of Different Organic Pollutants

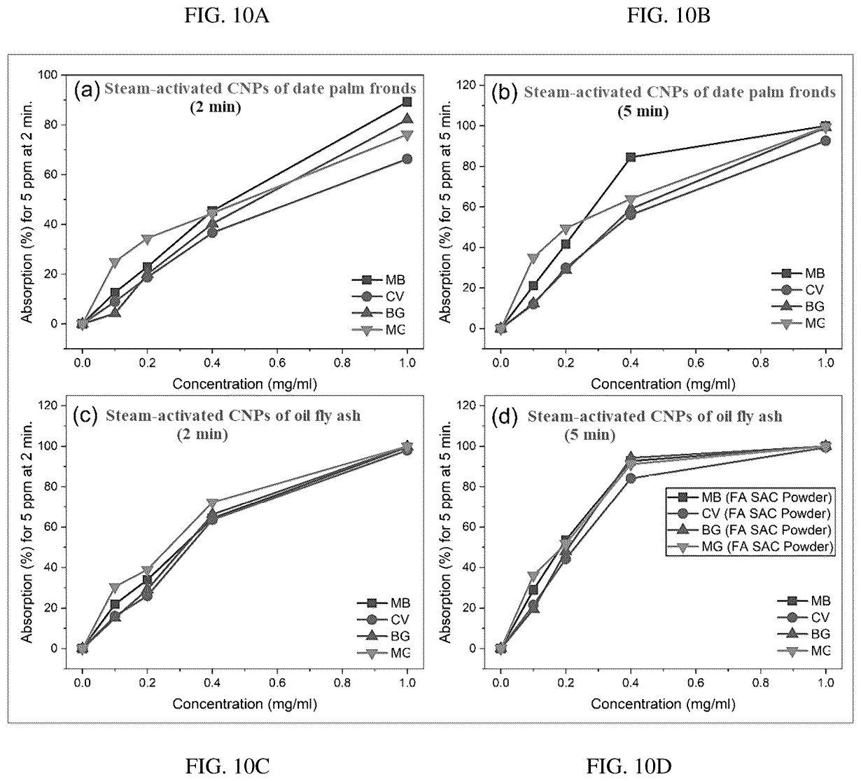

FIG. 10 and Table 3 show the effect of different concentrations in mg/ml in both steam-activated CNPs of date palm fronds powder as depicted in FIGS. 10 (A and B) and CNPs of oil fly ash powder as shown in FIGS. 10 (C and D), respectively for 2- and 5-minute adsorption time of different organic pollutants. It appears that the percentage of dye adsorption increased with increasing concentrations of both CNPs of oil fly ash and CNPs of date palm fronds, respectively.

TABLE 3
The absorbance of different organic pollutants at different concentrations
of the steam-activated CNPs of oil fly ash and date palm fronds powders.

| Concentration | Adsorption (%) | | | |
|---|---|---|---|---|
| (mg/ml) | MB | CV | BG | MG |

Steam Activated CNPs of Date Palm Fronds in 5 ppm Solution at a Fixed Time of 2 min

| | | | | |
|---|---|---|---|---|
| 0.1 | 12.61 | 8.94 | 4.19 | 25 |
| 0.2 | 22.92 | 18.67 | 19.95 | 34.44 |
| 0.4 | 45.37 | 36.63 | 40.27 | 44.44 |
| 1 | 89.21 | 66.26 | 82.14 | 76.11 |

Steam Activated CNPs of Date Palm Fronds in 5 ppm Solution at a Fixed Time of 5 min

| | | | | |
|---|---|---|---|---|
| 0.1 | 21.11 | 11.92 | 12.32 | 35 |
| 0.2 | 41.55 | 29.97 | 28.82 | 49.44 |
| 0.4 | 84.43 | 56 | 58.99 | 63.89 |
| 1 | 99.9 | 92.55 | 99.14 | 99.44 |

Steam Activated CNPs of oil Fly Ash in 5 ppm Solution at a Fixed Time of 2 min

| | | | | |
|---|---|---|---|---|
| 0.1 | 21.87 | 15.95 | 15.02 | 30.56 |
| 0.2 | 33.91 | 25.94 | 29.06 | 38.89 |
| 0.4 | 64.18 | 63.54 | 66.13 | 72.22 |
| 1 | 99.52 | 97.9 | 99.75 | 100 |

Steam Activated CNPs of oil Fly Ash in 5 ppm Solution at a Fixed Time of 5 min

| | | | | |
|---|---|---|---|---|
| 0.1 | 28.84 | 21.47 | 19.46 | 36.11 |
| 0.2 | 53.49 | 44.17 | 47.78 | 51.67 |
| 0.4 | 92.65 | 84.05 | 94.21 | 91.11 |
| 1 | 100 | 99.3 | 100 | 100 |

Coated Fabrics with Steam-Activated CNPs of Date Palm Fronds

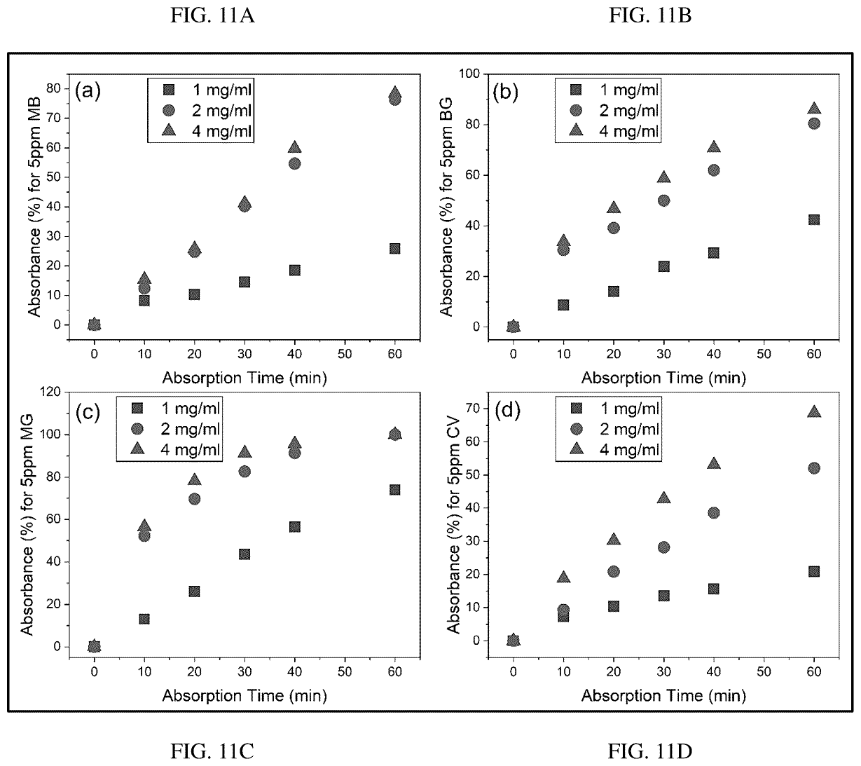

The adsorption performance of CNPs of date palm fronds coated fabrics (containing 80% CNPs and 20% PMMA) was tested with different quantities of CNPs on the fabric, which are 50±2 mg, 100±4, and 200±5 mg, per 2×2 cm fabric sheets. These coated fabrics were immersed in 50 ml of DI water and placed in a shaker while recording the adsorptions at different times, as shown in FIGS. 11A-D and Table 4, respectively. These amounts of CNPs in 50 ml DI water have concentrations equal to 1, 2, and 4 mg/ml. The concentration of the pollutants including methylene blue (MB), brilliant green (GB), methyl green (MG), and crystal violet (CV) was kept at 5 ppm throughout the study.

This section discusses the adsorption performance of the coated fabrics of different organic pollutants. The solution 5 ppm of each organic pollutant was tested for 5 to 30 minutes. The coated fabrics were immersed in 50 ml of the 5-ppm pollutant solution and placed in a shaker for 30 minutes while the adsorption performance was tested at intervals of 5 minutes.

TABLE 4
The adsorption performance of CNPs of date palm fronds coated
fabrics in various pollutants at different concentrations.

Adsorption %

| | | | | |
|---|---|---|---|---|
| Adsorption Time | MB | BG | MG | CV |
| (min) | (5 ppm) | (5 ppm) | (5 ppm) | (5 ppm) |

1 mg/ml (CNPs of date palm fronds Coated Fabrics)

| | | | | |
|---|---|---|---|---|
| 10 | 8.25 | 8.7 | 13.04 | 7.29 |
| 20 | 10.31 | 14.13 | 26.09 | 10.42 |
| 30 | 14.43 | 23.91 | 43.48 | 13.54 |
| 40 | 18.56 | 29.35 | 56.52 | 15.63 |
| 60 | 25.77 | 42.39 | 73.91 | 20.83 |

2 mg/ml (CNPs of date palm fronds Coated Fabrics)

| | | | | |
|---|---|---|---|---|
| 10 | 12.37 | 30.43 | 52.17 | 9.38 |
| 20 | 24.74 | 39.13 | 69.57 | 20.83 |
| 30 | 40.21 | 50 | 82.61 | 28.13 |
| 40 | 54.64 | 61.96 | 91.3 | 38.54 |
| 60 | 76.29 | 80.43 | 100 | 52.08 |

4 mg/ml (CNPs of date palm fronds Coated Fabrics)

| | | | | |
|---|---|---|---|---|
| 10 | 15.46 | 33.7 | 56.52 | 18.75 |
| 20 | 25.77 | 46.74 | 78.26 | 30.21 |
| 30 | 41.23 | 58.7 | 91.3 | 42.7 |
| 40 | 59.79 | 70.65 | 95.65 | 53.13 |
| 60 | 78.35 | 85.87 | 100 | 68.75 |

### Effect of Different Concentrations of CNPs of Oil Fly Ash/Date Palm Frond Powder in the Absorption Performance

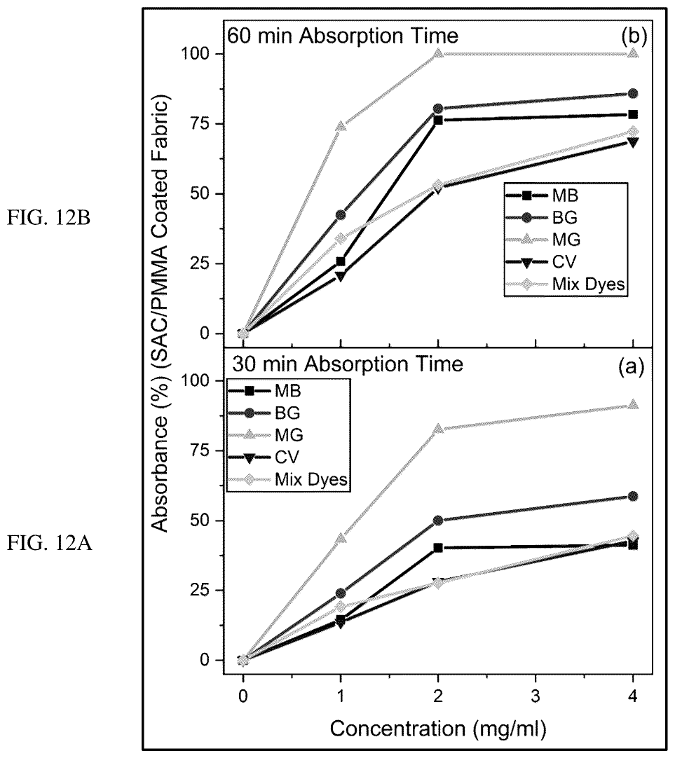

The effect of concentrations in the adsorption percentage of CNPs of date palm fronds coated fabrics are presented in FIG. 12A (60 minutes adsorption time) and FIG. 12B (30 minutes adsorption time), respectively. It could be observed that the adsorption percentage sharply increased from 1 mg/ml to 2 mg/ml, after that, the adsorption becomes relatively sluggish with little or no increase up to 4 mg/ml. Hence, these indicate that there are no significant differences between the adsorption performance of the solution containing 2 mg/ml and the solution 10 containing 4 mg/ml. The summary of the data plotted in FIG. 6 is given in Table 5.

TABLE 5
The adsorption performance of CNPs of date palm fronds coated fabrics
in the mixture of pollutants at different concentrations.

| Adsorption | Mix Pollutants | Mix Pollutants | Mix Pollutants |
|---|---|---|---|
| Time (min) | (1 mg/ml; 5 ppm) | (2 mg/ml; 5 ppm) | (4 mg/ml; 5 ppm) |
| 10 | 8.51 | 10.64 | 19.15 |
| 20 | 12.77 | 19.15 | 31.91 |
| 30 | 19.15 | 27.66 | 44.68 |
| 40 | 23.4 | 36.17 | 55.32 |
| 60 | 34.04 | 53.19 | 72.34 |

Absorption Performance of Coated Fabrics with Steam-Activated CNPs of Oil Fly Ash

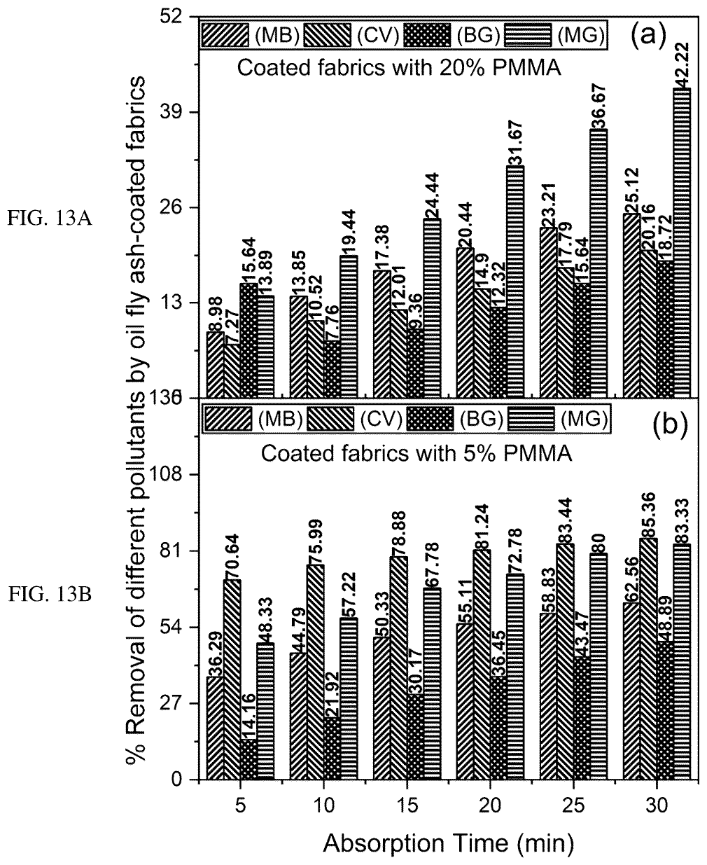

The percentage adsorption of dyes by two different CNPs of oil fly ash-coated fabrics; with one containing 20% of PMMA and the other containing 5% of PMMA are presented in FIG. 13A and FIG. 13B, respectively. The tested quantity used herein is 200 mg in 50 ml of 5 ppm dye solutions. The adsorption performance of these coated fabrics was tested for the adsorption time between 5 minutes and 30 minutes, respectively. Reducing the percentage of the PMMA in the coated fabrics appears to be an effective way to improve the adsorption performance as shown in FIG. 13B. However, decreasing the PMMA percentage in the coating has some disadvantages of risking the releasing of the coated carbon into treated water. The summary of the adsorption performance of both fabrics is also presented in Table 6.

TABLE 6
The adsorption performance of CNPs of oil fly ash-coated fabrics
in various pollutants at a fixed concentration of 4 mg/ml.

Adsorption %

| | Coated Fabrics | Coated Fabrics | Coated Fabrics | Coated Fabrics |
|---|---|---|---|---|
| Adsorption | with 20% | with 20% | with 20% | with 20% |
| Time (min) | PMMA (MB) | PMMA (CV) | PMMA (BG) | PMMA (MG) |
| 5 | 8.98 | 7.27 | 15.64 | 13.89 |
| 10 | 13.85 | 10.52 | 7.76 | 19.44 |
| 15 | 17.38 | 12.01 | 9.36 | 24.44 |
| 20 | 20.44 | 14.9 | 12.32 | 31.67 |
| 25 | 23.21 | 17.79 | 15.64 | 36.67 |
| 30 | 25.12 | 20.16 | 18.72 | 42.22 |

| | Coated Fabrics | Coated Fabrics | Coated Fabrics | Coated Fabrics |
|---|---|---|---|---|
| Adsorption | with 5% PMMA | with 5% PMMA | with 5% PMMA | with 5% PMMA |
| Time (min) | (MB) | (CV) | (BG) | (MG) |
| 5 | 36.29 | 70.64 | 14.16 | 48.33 |
| 10 | 44.79 | 75.99 | 21.92 | 57.22 |
| 15 | 50.33 | 78.88 | 30.17 | 67.78 |
| 20 | 55.11 | 81.24 | 36.45 | 72.78 |
| 25 | 58.83 | 83.44 | 43.47 | 80 |
| 30 | 62.56 | 85.36 | 48.89 | 83.33 |

### Pellets of CNPs of Oil Fly Ash-Organic Pollutants/Dyes Absorption Performance Test

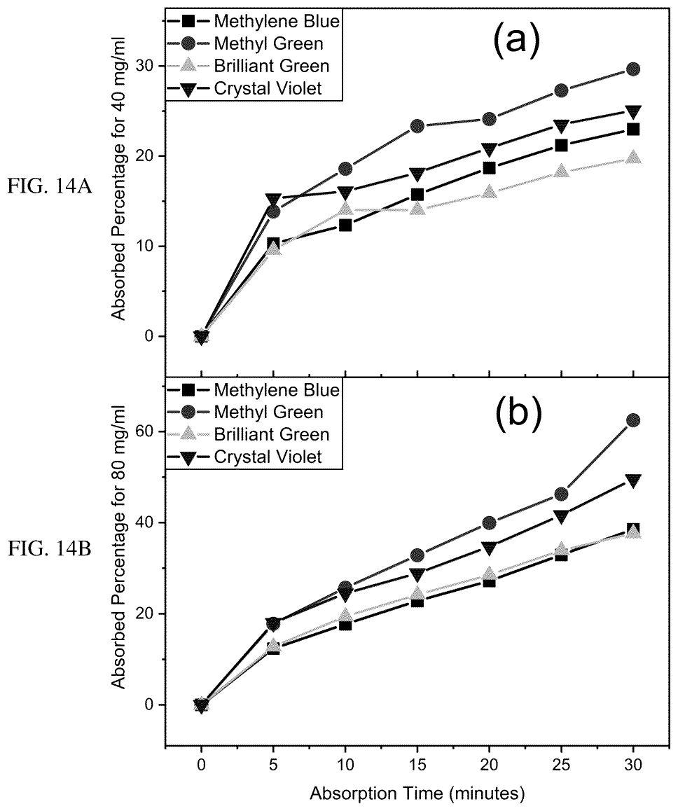

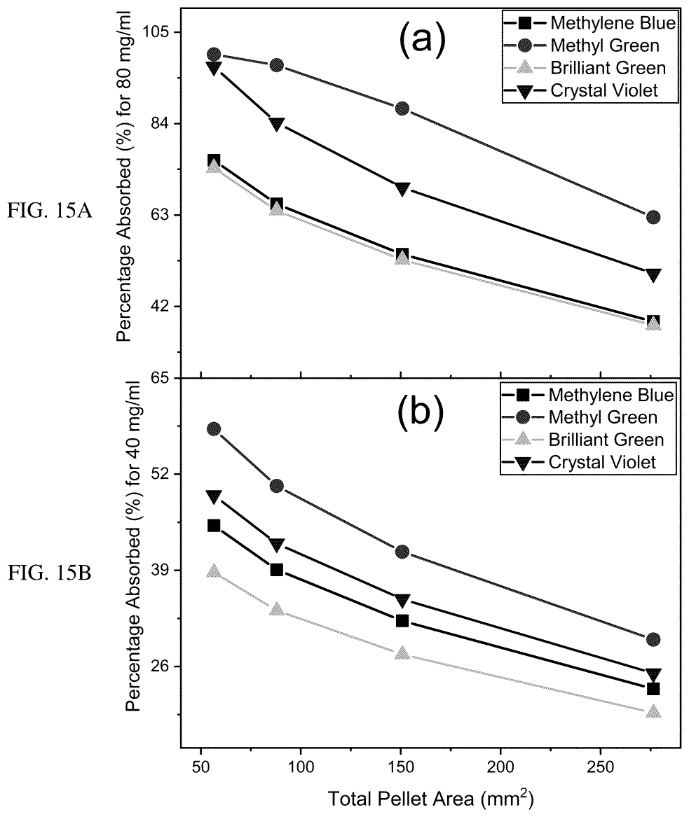

The adsorption performance of pellets made of steam activated CNPs of oil fly ash at two different concentrations namely 40 mg/ml and 80 mg/ml is shown in FIGS. 14A-B and Table 7. It could be observed that the tests were conducted on four different organic pollutants such as methylene blue (MB), methyl green (MG), brilliant green (BG), and crystal violet (CV), respectively. The testing time adopted is between 5 minutes to 30 minutes. MG shows good absorption seconded by CV.

TABLE 7
The adsorption performance of steam-activated CNPs of oil fly
ash pellets containing 4% PMMA of different organic pollutants.

| | |
|---|---|
| Adsorption Time | Adsorption % |

| | | | | |
|---|---|---|---|---|
| (min) | MB | MG | BG | CV |

40 mg/ml (2 g in 50 ml of DI water) (%)

| | | | | |
|---|---|---|---|---|
| 5 | 10.29 | 13.83 | 9.57 | 15.3 |
| 10 | 12.34 | 18.58 | 14.04 | 16.09 |
| 15 | 15.74 | 23.32 | 14.04 | 18.14 |
| 20 | 18.69 | 24.11 | 15.90 | 20.9 |
| 25 | 21.2 | 27.27 | 18.21 | 23.5 |
| 30 | 22.99 | 29.64 | 19.75 | 25.08 |

80 mg/ml (4 g in 50 ml of DI water) (%)

| | | | | |
|---|---|---|---|---|
| 5 | 12.34 | 17.79 | 12.81 | 17.98 |
| 10 | 17.71 | 25.69 | 19.44 | 24.45 |
| 15 | 22.81 | 32.81 | 24.23 | 28.86 |
| 20 | 27.19 | 39.92 | 28.55 | 34.7 |
| 25 | 32.92 | 46.25 | 33.95 | 41.64 |
| 30 | 38.55 | 62.45 | 37.65 | 49.53 |

Effect of Different Sizes (and/or Areas) of Pellets Made of Steam Activated CNPs of Oil Fly Ash on the Organic Pollutant's Absorption Performance

The effect of total pellet area (e.g. size of the pellet) on the adsorption performance of different concentrations such as 80 and 40 mg/ml are presented in FIG. 15A and FIG. 15B, respectively. The original dimensions of the produced fly ash pellets were 20 mm (length) and 4 mm (diameter) with a total area of 276.4 mm². Later, the pellets were reduced into different lengths including 10 mm, 5 mm, and 2.5 mm, respectively. The absorption performance of the pellets significantly improved when the pellets were reduced into smaller pieces as shown in FIG. 15 and Table 8, respectively. These results show that as the total pellet area (surface area) increases, the performance was significantly improved.

TABLE 8
The percentage adsorption over 80 mg/ml and 40 mg/ml pollutant
concentrations based on different pellet area of pellet
(pellets of steam activated CNPs of oil fly ash).

| | | | | |
|---|---|---|---|---|
| Total Pellet | Adsorption % | | | |
| Area (mm²) | MB | MG | BG | CV |

Percentage Adsorption over 80 mg/ml

| | | | | |
|---|---|---|---|---|
| 276.4 | 38.55 | 62.48 | 37.65 | 49.53 |
| 66.11 | 53.97 | 87.43 | 52.72 | 69.34 |
| 17.28 | 65.54 | 97.4 | 64.01 | 84.2 |
| 4.32 | 75.56 | 99.9 | 73.8 | 97.07 |

Percentage Adsorption over 40 mg/ml

| | | | | |
|---|---|---|---|---|
| 276.4 | 22.99 | 29.64 | 19.75 | 25.08 |
| 66.11 | 32.18 | 41.5 | 27.65 | 35.11 |
| 17.28 | 39.08 | 50.4 | 33.58 | 42.63 |
| 4.32 | 45.06 | 58.1 | 38.72 | 49..15 |

### Adsorption Performance of Non Activated and Steam Activated CNPs of Fly Ash in Powder Form as Well as in Fabric-Coated Forms for Some Toxic Metals

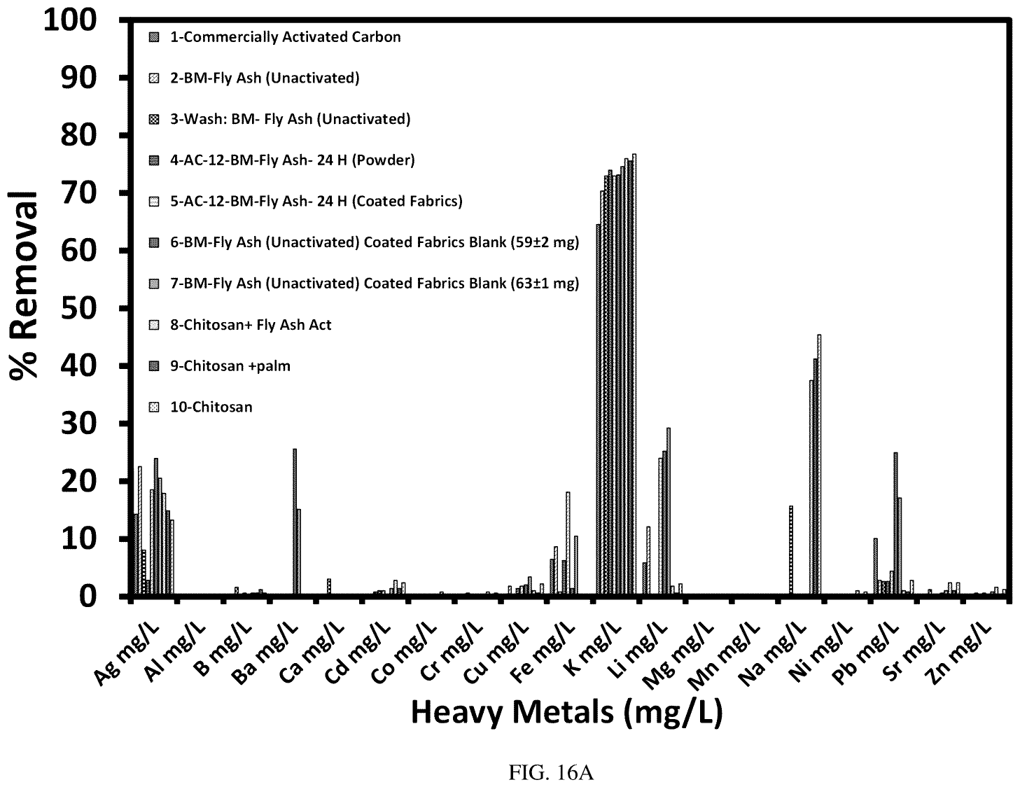

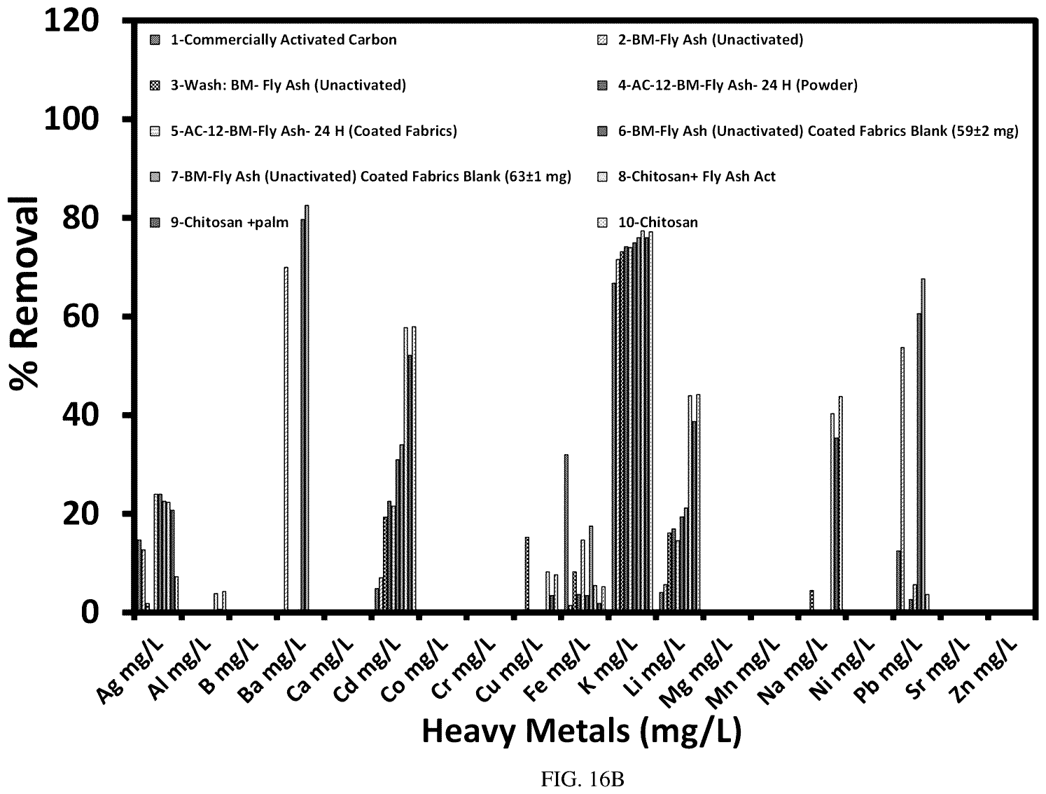

The variety of adsorbent such as commercial activated carbon powder, CNPs of oil fly ash powder (Ball milled sample: BM), washed CNPs of oil fly ash powder, steam activated CNPs of oil fly ash coated fabric, and non-activated CNPs of oil fly ash coated fabric were tested for heavy metals removal. Other adsorbents like a powder mixture of activated CNPs of oil fly ash with chitosan, a powder mixture of activated CNPs of date palm fronds with chitosan, and pure chitosan powder were also included in this study. They were tested for their adsorption of a good number of metals, which are the most abundant pollutants in industrial wastewater. These are Ag, Al, B, Ba, Ca, Cd, Co, Cr, Cu, Fe, K, Li, Mg, Mn, Na, Ni, Pb, Sr, and Zn. FIGS. 16a and b illustrate the performance of heavy metal removal in the time span of 60 min and 120 min respectively. It shows that some elements/ions like Ag, Al Ba, Cd, K, Li, Ni, and Pb were significantly removed, even better than those removed by the commercial activated carbon.

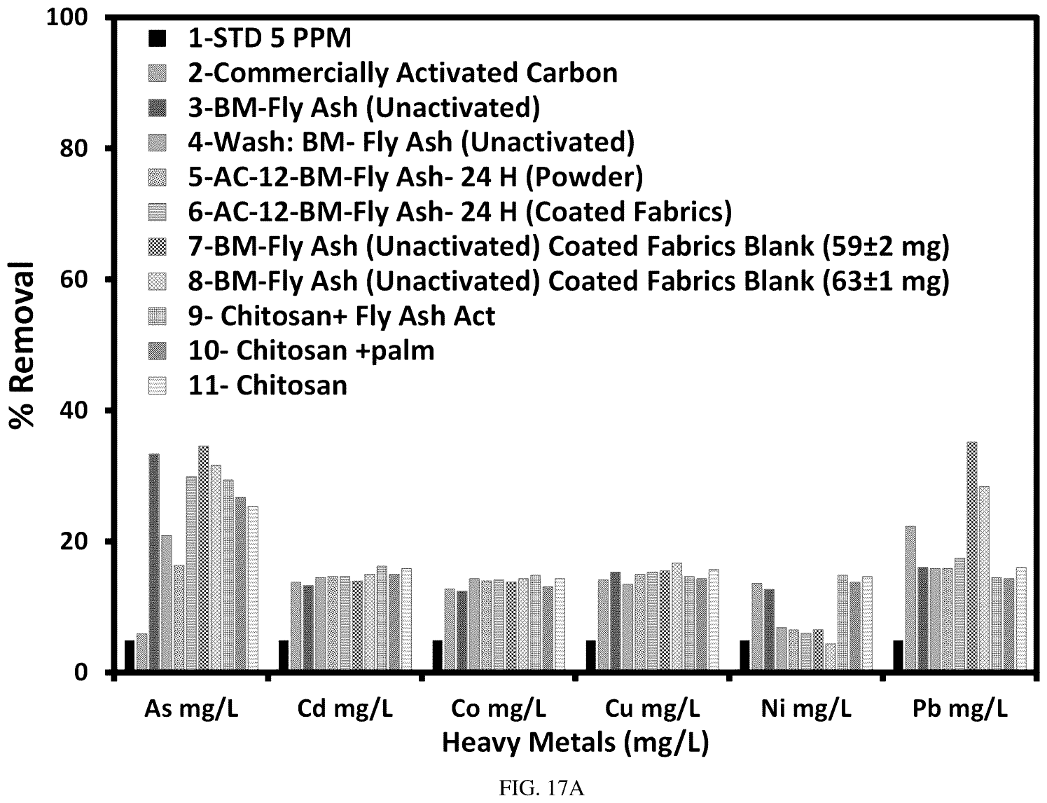

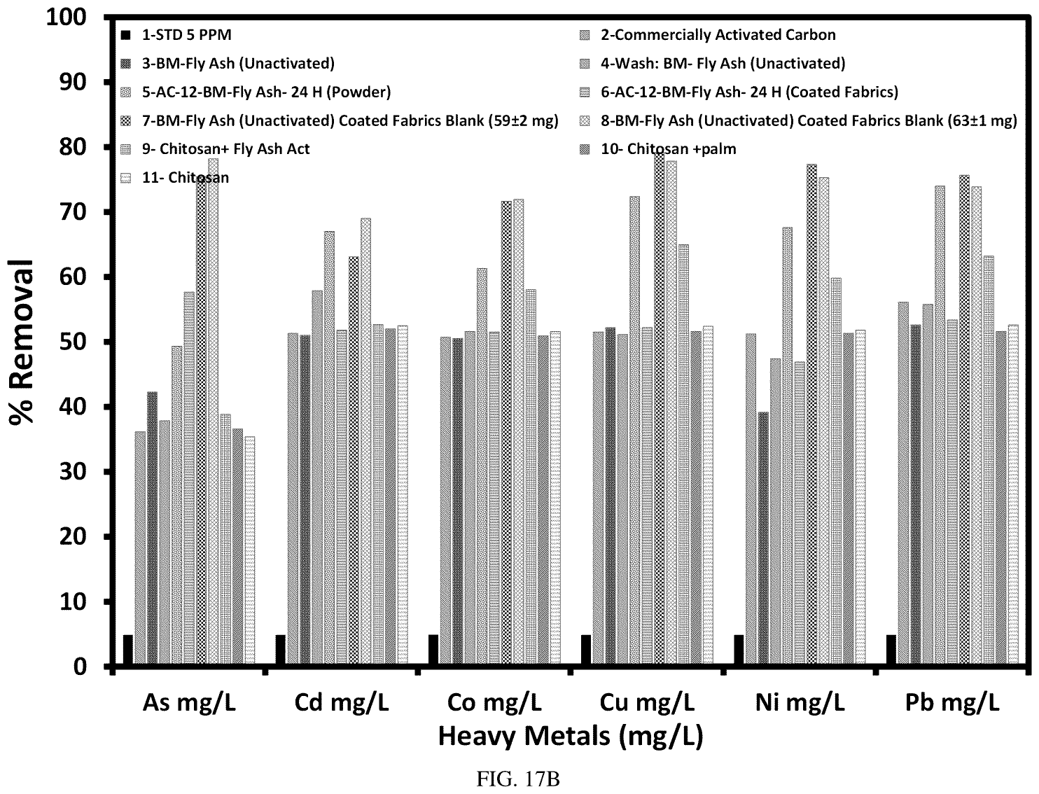

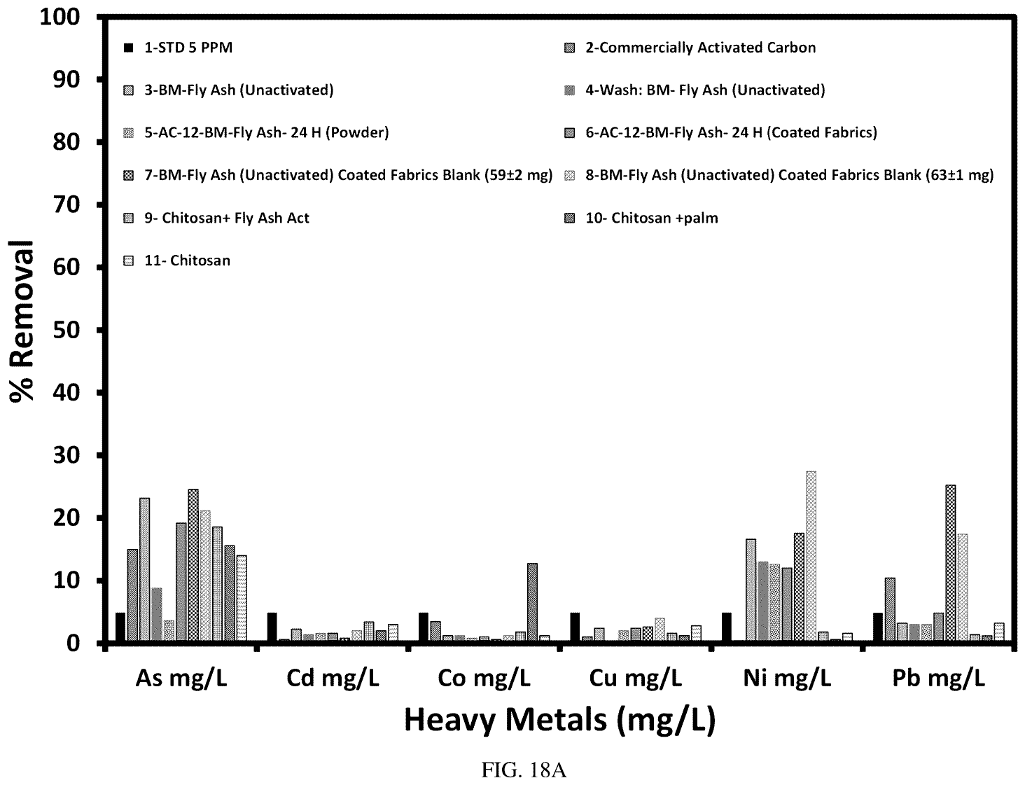

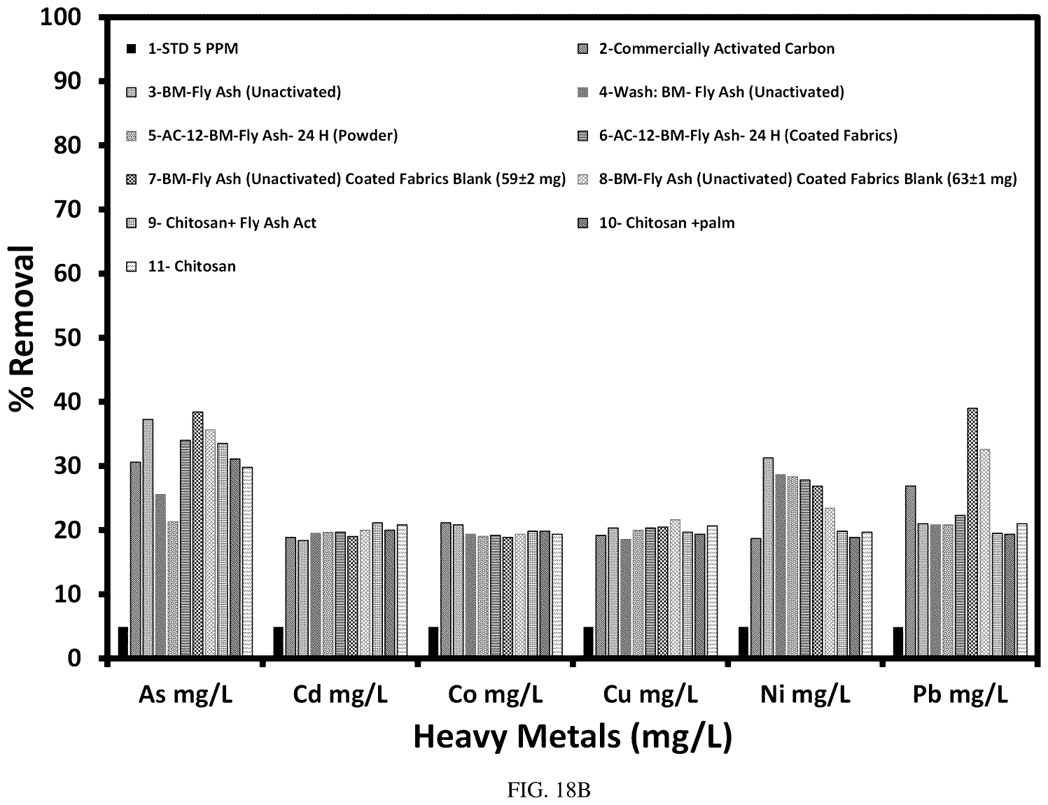

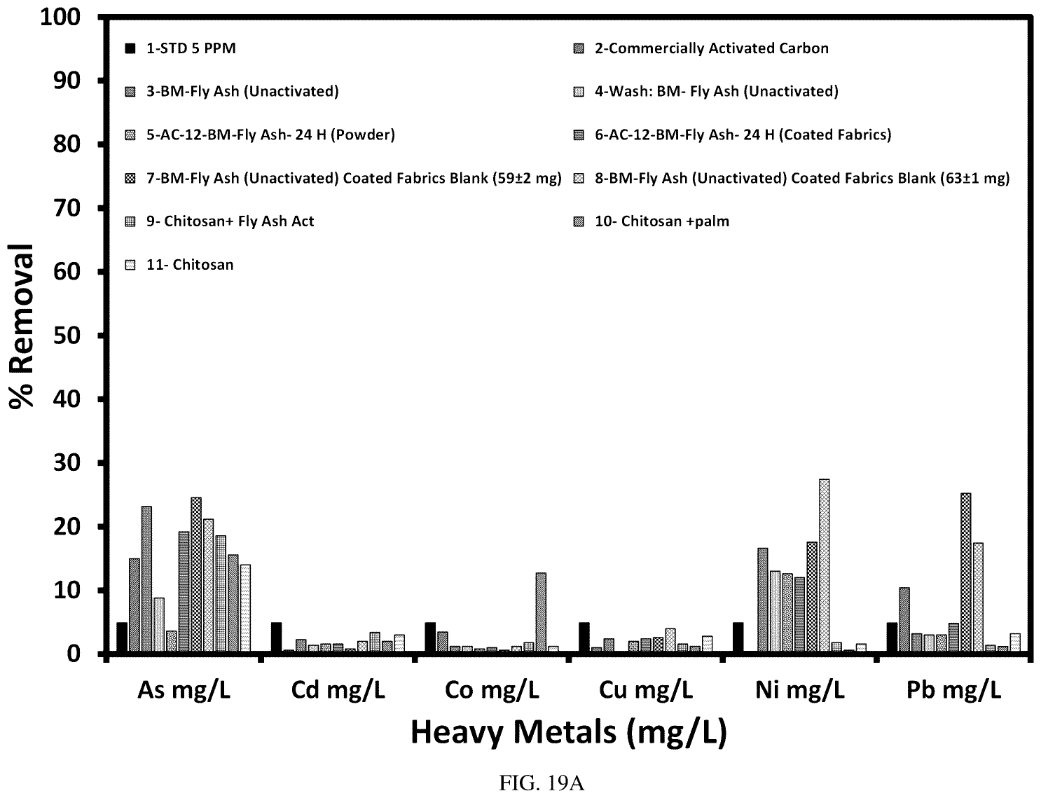

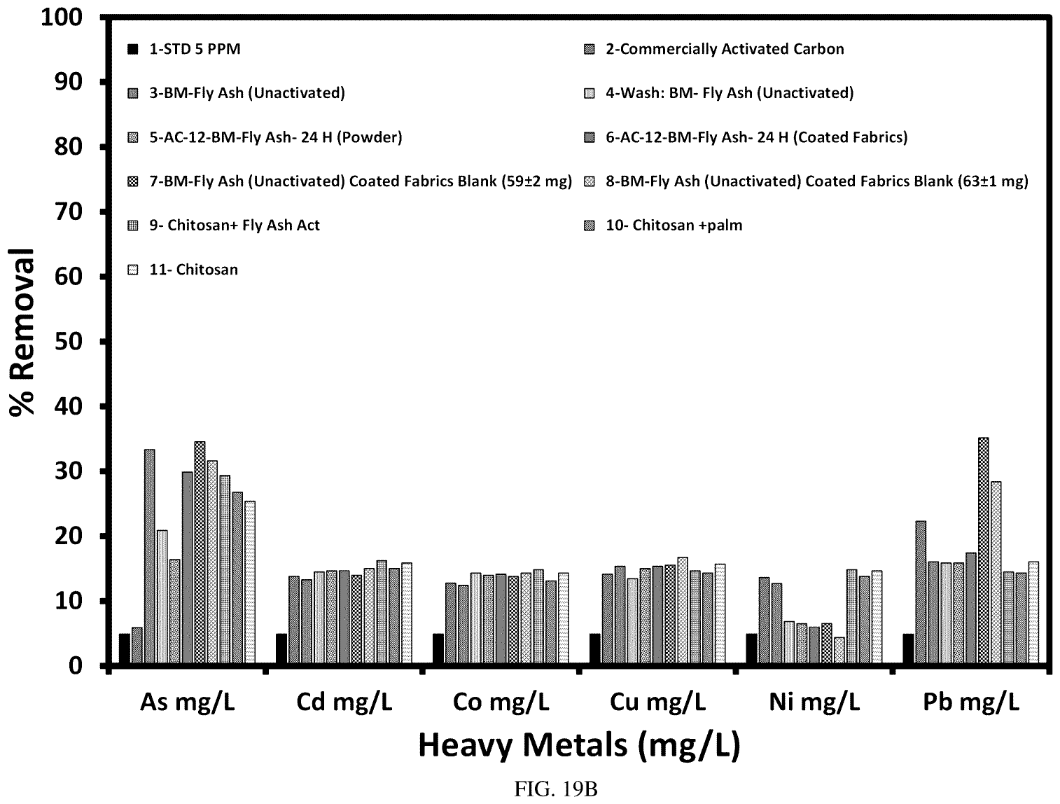

The removal of some selected toxic metals at a concentration of 5 ppm was also tested by the above-mentioned carbon nanoparticles. They were tested for their adsorption at different exposure times and different pH conditions as shown in the FIG. 17-19. At pH 6-7, as presented in FIGS. 17A and B, some elements/ions like Ag, Al Ba, Cd, K, Li, Ni, and Pb were significantly removed. A good percentage of these elements were removed even in a short time e.g. 30 min. Reducing the pH value (at pH 4-5) has significantly reduced the removal power of the above carbon nanomaterials as shown in FIG. 18A-B. When the pH value increased (at pH 8-9), the removal power of the above carbon nanomaterials was also lower than those at a pH value within the range of 6-7 as shown in FIG. 19A-B.

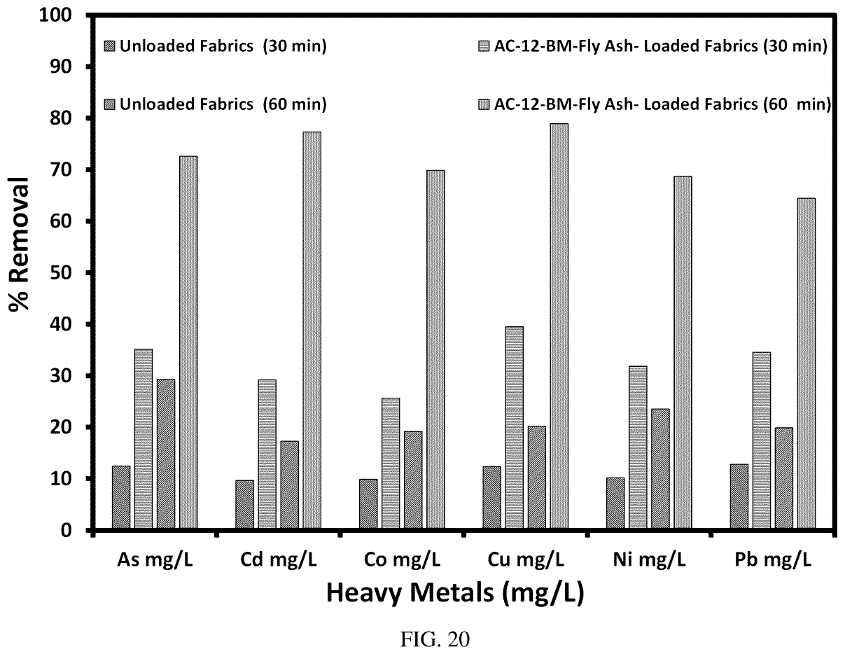

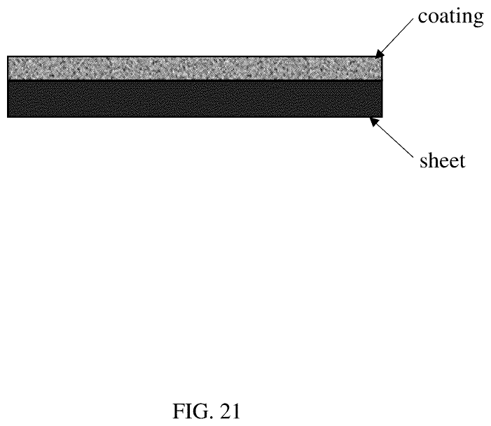

The results presented in FIGS. 16-19 showed that the activated CNPs of oil fly ash coated fabric samples are the best for the removal of these metal ions. The data presented in FIG. 20 shows these remarkable results. The result of the uncoated fabric is also shown in this figure. At 60 min of exposure time the removal of As, Cd, Co, Cu, Ni, and Pb reached around 80%. These metal ions are highly toxic if present in pollutant water.

### Acknowledgment

The inventors extend their appreciation to the Deputyship for Research & Innovation, Ministry of Education in Saudi Arabia for funding this research work through the project number “IFPPT-1-2022” and King Abdulaziz University, DSR, Jeddah, Saudi Arabia.

### REFERENCES

[1] Kumar, S. (2013). “The Looming Threat of Water Scarcity.” Worldwatch Institute Retrieved Retrieved 14 Jan. 2015, from vitalsigns.worldwatch.org/node/180.
[2] Schenkeveld, M. M., et al. (2004). “Seawater and Brackish Water Desalination in the Middle East, North Africa and Central Retrieved 14 Mar. 2013, from Asia.” siteresources.worldbank.org/INTWSS/Resources/Desal_mainreport-Final2.pdf
[3] Peter J. Hotez, Bernard Pecoul, Suman Rijal, Catharina Boehme, Serap Aksoy, Mwelecele Malecela, Roberto Tapia-Conyer, John C. Reeder. Eliminating the Neglected Tropical Diseases: Translational Science and New Technologies. PLOS Neglected Tropical Diseases. 10 (3), 2016, e0003895.
[4] WHO/Department of Control of neglected tropical diseases. Investing to Overcome the Global Impact of Neglected Tropical Diseases: Third WHO Report on Neglected Tropical Diseases 2015.
[5] Singh, R. P., Singh, P. K., Gupta, R., Singh, R. L., 2019. Treatment and recycling of wastewater from textile industry. Advances in biological treatment of industrial waste water and their recycling for a sustainable future 225-266.
[6] Man, Y., Han, Y., Wang, Y., Li, J., Chen, L., Qian, Y., Hong, M., 2018. Woods to goods: water consumption analysis for papermaking industry in China. J. Clean. Prod. 195, 1377-1388.
[7] Norgate, T., Haque, N., 2010. Energy and greenhouse gas impacts of mining and mineral processing operations. J. Clean. Prod. 18 (3), 266-274.
[8] Fthenakis, V., Kim, H. C., 2010. Life-cycle uses of water in US electricity generation. Renew. Sustain. Energy Rev. 14 (7), 2039-2048.
[9] Compton, M., Willis, S., Rezaie, B., Humes, K., 2018. Food processing industry energy and water consumption in the Pacific northwest. Innovate. Food Sci. Emerg. Technol. 47, 371-383.
[10] Sodhi, H. S., Singh, D., Singh, B. J., 2020a. A conceptual examination of Lean, Six Sigma and Lean Six Sigma models for managing waste in manufacturing SMEs. World J. Sci. Technol. Sustain. Dev. 17 (1), 20-32.
[11] Li, J., See, K. F., Chi, J., 2019. Water resources and water pollution emissions in China's industrial sector: a green-biased technological progress analysis. J. Clean. Prod. 229, 1412-1426.
[12] Colella, M., Ripa, M., Cocozza, A., Panfilo, C., Ulgiati, S., 2021b. Challenges and opportunities for more efficient water use and circular wastewater management. The case of Campania Region, Italy. J. Environ. Manag. 297, 113171.
[13] Tong, Y., Huang, Z., Janssen, A. B. G., Wishart, M., He, W., Wang, X., Zhao, Y., 2022. Influence of social and environmental drivers on nutrient concentrations and ratios in lakes: a comparison between China and Europe. Water Res. 227, 119347.
[14] Xu, A., Wu, Y. H., Chen, Z., Wu, G., Wu, Q., Ling, F., Huang, W. E., Hu, H. Y., 2020. Towards the new era of wastewater treatment of China: development history, current status, and future directions. Water Cycle 1, 80-87.
[15] Atangana, E., Oberholster, P. J., Turton, A. R., 2021. Will the extraction of COVID-19 from wastewater help flatten the curve? Chemosphere 271, 129429.
[16] Zou, Y., Li, Q., Tao, T., Ye, P., Zhang, P., Liu, Y., 2021. Fe-Mn binary oxides activated aluminosilicate mineral and its Tl (I) removal by oxidation, precipitation and adsorption in aqueous. J. Solid State Chem. 303, 122383.
[17] Dwivedi, K. A., Huang, S.-J., Wang, C.-T., 2022. Integration of various technology-based approaches for enhancing the performance of microbial fuel cell technology: a review. Chemosphere 287, 132248.
[18] Verstraete, W., Yanuka-Golub, K., Driesen, N., De Vrieze, J., 2022. Engineering microbial technologies for environmental sustainability: choices to make. Microb. Biotechnol. 15 (1), 215-227.
[19] Nunes, O. C., 2021. The challenge of removing waste from wastewater: let technology use nature. Microb. Biotechnol. 14 (1), 63-67.
[20] E. H. Sujiono, D. Zabrian, Zurnansyah, Mulyati, V. Zharvan, Samnur, N. A. Humairah. Fabrication and characterization of coconut shell activated carbon using variation chemical activation for wastewater treatment application. Results in Chemistry 4 (2022) 100291.
[21] Sharon Lustenberger, Roberto Castro-Muñoz. Advanced biomaterials and alternatives tailored as membranes for water treatment and the latest innovative European water remediation projects: A review. Case Studies in Chemical and Environmental Engineering 5 (2022) 100205.
[22] V. E. Efeovbokhan, O. O. Olurotimi, E. O. Yusuf, O. G. Abatan and E. E. Alagbe. Production of Clay Filters for Waste Water Treatment. Journal of Physics: Conference Series 1378 (2019) 032028.
[23] Manav G. Patel, Parth G. Marakana, Anirban Dey, Bharti Saini, Himanshu Chokshi. Coal fly ash derived adsorbent for enhancing waste water treatment. Materials today Proceeding 77 (2023) 163-167.
[24] Asim Ali Yaqoob, Tabassum Parveen, Khalid Umar and Mohamad Nasir Mohamad Ibrahim. Role of Nanomaterials in the Treatment of Wastewater: A Review. Water 12 (2020) 495.
[25] S. Zahmatkesh, M. Hajiaghaei-Keshteli, A. Bokhari, S. Sundaramurthy, B. Panneerselvam, Y. Rezakhani. Wastewater treatment with nanomaterials for the future: A state-of-the-art review. Environmental Research 216 (2023) 114652.
[26] Feng Lu, Didier Astru. Review; Nanocatalysts and other nanomaterials for water remediation from organic pollutants. Coordination Chemistry Reviews 408 (2020) 213180.
[27] Mahmoud Nasrollahzadeh, Mohaddeseh Sajjadi, Siavash Iravani, Rajender S. Varma. Review; Carbon-based sustainable nanomaterials for water treatment: State-of-art and future perspectives. Chemosphere 263 (2021) 128005.
[28] S. S. Banerjee, M. V. Joshi, R. V. Jayaram. Removal of Cr (VI) and Hg (II) from Aqueous Solutions Using Fly Ash and Impregnated Fly Ash. Separation Science and Technology. 39 (7), 2005, 1611-1629.
[29] Sirajus Salehin, et al. Desalination and Water Treatment 57 (1) (2016), 278-287
[30] Agnieszka Adamczuk, Dorota Kołodyńska. Equilibrium, thermodynamic and kinetic studies on removal of chromium, copper, zinc and arsenic from aqueous solutions onto fly ash coated by chitosan. Chemical Engineering Journal. 274, 2015, 200-212.
[31] Li Moumita Maiti, Manas Sarkar, Muhammad Akbar Malik, Shilang Xu, Qinghua, and Saroj Mandal. Iron Oxide NPs Facilitated a Smart Building Composite for Heavy-Metal Removal and Dye Degradation. ACS Omega 2018, 3, 1, 1081-1089
[32] Numan Abdullah Salah, (2013), Forming Carbon Nanotubes from Carbon rich fly ash, U.S. Patent Number: U.S. Pat. No. 8,609,189 B2.
[33] Numan Salah, et al. (2016), Materials and Manufacturing Processes 31, 146.
[34] Numan Salah, et al, Desalination and Water Treatment 57 (45) (2016) 21534-21544.
[35] Numan Salah, et al, Synthesis of carbon nanotubes using pre-sintered oil fly ash via a reproducible process with large-scale potential. Methods 199 (2022) 37-53.
[36] Numan Salah, et al, Lubricant additives based on carbon nanotubes produced from carbon rich fly ash. Tribology Transaction 60 (2017) 166.
[37] Numan Salah, et al, Nano and micro structures produced from carbon rich fly ash as effective lubricant additives for 150SN base oil. Journal of Materials Research and Technology 8 (2019) 250-258.
[38] Numan Salah, et al, Carbon nanotubes of oil fly ash as lubricant additives for different base oils and their tribology performance. RSC Advances 7 (2017) 40295.
[39] Numan Salah, et al, Water treatment system and methods thereof, U.S. Patent Number: U.S. Pat. No. 10,752,527B2 (2020).
[40] Numan Salah, et al, Effective reinforcements for thermoplastics based on carbon nanotubes of oil fly ash. Scientific Reports 9 (2019) 20288.
[41] Numan Salah, et al, Size-controlled, single-crystal CuO nanosheets and the resulting polyethylene-carbon nanotube nanocomposite as antimicrobial materials. Polymer Bulletin 78 (2021) 261-281.
[42] Numan Salah, et al, Thermoelectric properties of oil fly ash-derived carbon nanotubes coated with polypyrrole, J. Applied Physics 128 (23), (2020) 235104
[43] Numan Salah, et al, Carbon Rich Fly Ash and their Nanostructures, Carbon letters 19 (2016) 23-31
[44] Numan Salah, et al. Method for removing polycyclic aromatic hydrocarbons from water using ball milled and sonicated oil fly ash powder U.S. Patent Number: U.S. Pat. No. 11,110,429 B1 (2021).
[45] A Algarni et al, Polymer composite reinforced with nanoparticles produced from graphitic carbon-rich fly. Journal of Composite Materials 51 (2017) 2675.
[46] Jia-Hao Kang, Jenn-Shing Chen. Using ethylenediamine to prepare three-dimensional nitrogen-doped graphene aerogel/sulfur composite for lithium-sulfur batteries. Diamond and Related Materials. 88, 2018, 222-229.
[47] Cheng Chen, Xiaoying Zhu, Baoliang Chen. Covalently cross-linked graphene oxide aerogel with stable structure for high-efficiency water purification. Chemical Engineering Journal. 354, 2018, 896.
[48] Jie Cai, Satoshi Kimura, Masahisa Wada, Shigenori Kuga, Lina Zhang. Cellulose aerogels from aqueous alkali hydroxide-urea solution. ChemSusChem. 1 (1-2), 2008, 149-154.
[49] I. H. Ismail, et al. Analyzing the Spatial Correspondence between Different Date Fruit Cultivars and Farms' Cultivated Areas, Case Study: Al-Ahsa Oasis, Kingdom of Saudi Arabia. Appl. Sci. 2022, 12 (11), 5728
[50] K. N. Al-Redhaiman, Date Palm Cultivation in Saudi Arabia: Current Status and Future Prospects for Development, 2014 ASHS Annual Conference.
[51] S. Zafar, Date Palm as Biomass Resource, Jul. 12, 2019. (bioenergyconsult.com/date-palm-biomass).
[52] A. Yacob, and H M Al Swaidan, Phosphoric Acid Effect on Prepared Activated Carbon from Saudi Arabia's Date Frond Waste, Applied Mechanics and Materials Vols 110-116 (2012) pp 2124-2130.
[53] A. F. Ahmad, and G. A. ElChaghaby, Palm Fronds Activated Carbon for the Removal of Brilliant Green Dye from Wastewater, Water and Desalination Research Journal Vol. 2, No. 1; 2018.
[54] Falah H. Hussein, et al, Preparation and Characterization of Activated Carbon from Iraqi Khestawy Date Palm, Journal of Chemistry, Volume 2015, Article ID 295748, 8 pages.
[55] Ashfaq Ahmad, et al, Effect of different activating agents on the production of activated carbon from Raw Date Fronds of Saudi Palm Trees, Proc. of the Third Intl. Conf. Advances in Bio-Informatics, Bio-Technology and Environmental Engineering-ABBE 2015, ISBN: 978-1-63248-060-6 doi: 10.15224/978-1-63248-060-6-05.
[56] Numan Salah, et al. Methods of producing carbon nanoparticles. U.S. Patent Number. U.S. Pat. No. 10,906,812 B1 (2021).
[57] H Hussain, et al, Carbon dioxide activated carbonized date palm fronds free standing electrodes for highly efficient capacitive deionization of water. Inorganic Chemistry Communications 152 (2023) 110667.
[58] Humair Hussain, et al, Capacitive deionization of water using effective electrodes made of Carbon nanoparticles of date palm fronds, Under filing, U.S. Patent (2023).
[59] Shaik Muhammad U G Mohiuddin et al, Carbon Nanoparticles Extracted from Date Palm Fronds for Fluorescence Bioimaging: In Vitro Study. Journal of Functional Biomaterials 13 (2022) 218.
[60] NA Alhebshi, et al, Structural and Electrochemical Properties of Physically and Chemically Activated Carbon Nanoparticles for Supercapacitors. Nanomaterials 12 (2022) 122.
[61] X. Yang, Y. Wan, Y. Zheng, F. He, Z. Yu, J. Huang, H. Wang, Y. S. Ok, Y. Jiang, B. Gao, Surface functional groups of carbon-based adsorbents and their roles in the removal of heavy metals from aqueous solutions: a critical review, Chemical Engineering Journal, 366 (2019) 608-621.
[62] T. Wang, A. Rodriguez-Uribe, M. Misra, A. K. Mohanty, Sustainable carbonaceous biofiller from miscanthus: size reduction, characterization, and potential bio-composites applications, BioResources, 13 (2018) 3720-3739.
[63] P. Hadi, K. Y. Yeung, J. Barford, K. J. An, G. Mckay, Significance of “effective” surface area of activated carbons on elucidating the adsorption mechanism of large dye molecules, Journal of Environmental Chemical Engineering, 3 (2015) 1029-1037.
[64] H. Pikkor, H. Lees, A. Konist, O. Järvik, B. Maaten, Steam Activation of Oil Shale to Enhance the Porosity of Produced Semicoke, Energy Sources, Part A: Recovery, Utilization, and Environmental Effects, 44 (2022) 9064-9073.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A fabric sheet for removing contaminants from an aqueous solution, wherein the sheet is coated with steam-activated carbon nanoparticles obtained from oil fly ash and/or date palm fronds, wherein the carbon nanoparticles have an average particle size of 1-150 nm and wherein the carbon nanoparticles have been steam-activated at a temperature of 750-950° C.

2. The fabric sheet of claim 1, wherein the sheet is further coated with a binder mixed with the steam-activated carbon nanoparticles.

3. The fabric sheet of claim 2, wherein the sheet is coated with a mixture of 80-95% carbon nanoparticles and 5-20% binder.

4. The fabric sheet of claim 2, wherein the binder is poly (methyl methacrylate) (PMMA).

5. The fabric sheet of claim 1, wherein the sheet is formed from polystyrene.

6. The fabric sheet of claim 1, wherein the carbon nanoparticles have an average size of 1-10 nm.

7. The fabric sheet of claim 1, wherein the carbon nanoparticles are obtained from oil fly ash and date palm fronds.

8. The fabric sheet of claim 1, wherein the sheet is coated with steam-activated carbon nanoparticles using a drop casting technique.
